(19) United States
(12) Patent Application Publication
(10) Pub. No.: US 2004/0068068 A1
(43) Pub. Date: Apr. 8, 2004

(54) Optically active polymer with epoxide functions, method for preparing same, and use thereof

(76) Inventors: Marc Lemaire, Villeurbanne (FR); Christine Saluzzo, Lyon (FR); Alice Rolland, Montpellier (FR); Francois Touchard, Villeurbanne (FR); Damien Herault, Villeurbanne (FR)

Correspondence Address: YOUNG & THOMPSON, 745 SOUTH 23RD STREET 2ND FLOOR, ARLINGTON, VA, 22202

(21) Appl. No.: 10/432,550

(22) PCT Filed: Nov. 23, 2001
(86) PCT No.: PCT/FR01/03705

(30) Foreign Application Priority Data
Nov. 23, 2000 (FR) 00/15147

(51) Int. Cl. C08F 224/00

(52) U.S. Cl. 526/273

(57) ABSTRACT

The invention concerns an optically active polymer obtainable by free radical or anionic polymerisation of an optically active ethylene monomer with epoxide function bearing at least a chiral centre with a copolymerisable ethylene monomer. An example of such a polymer is an optically active copolymer consisting of two types of repeat units A and B of formula: (A), (B), wherein R⁰ to R¹², X, Y¹ and Y², B, * and n are such as defined in claim 1. Another example is an optically active monomer consisting of two types of repeat units A and C, A being as defined above and C corresponding to formula (C). Said polymers are useful, optionally after the epoxide functions are opened, for immobilising enzymes, as polymeric matrix for chiral chromatography, as polymeric support for solid phase synthesis, as ligand for preparing transition metal complexes in regioselective catalysis or as chiral inducer in regioselective catalyst.

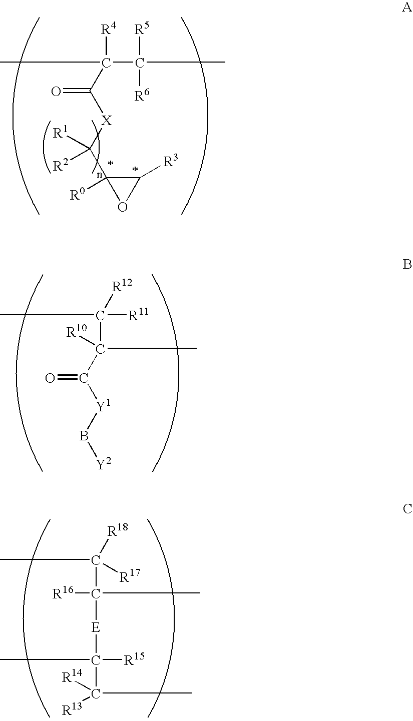

The invention concerns an optically active polymer having reactive epoxide functions, each epoxide function bearing at least one chiral centre. The invention moreover concerns a method for preparing said polymer, especially radically.

The invention moreover covers an optically active polymer derived from the above by opening of the epoxide functions (hereinafter designated modified polymer) and also a method for its preparation.

According to another of its features, the invention concerns the use of the polymer as a polymeric matrix in chiral chromatography, as a polymeric support in asymmetric solid phase synthesis or as ligand in the preparation of transition metal complexes intended for asymmetric catalysis, and also the use of said polymer as a reactive polymeric material for the immobilization of enzymes.

In addition, the invention makes available methods for preparing said polymers which permit modulation of the physical properaties such as appearance, porosity, specific surface area, size of the beads and resistance.

The principal advantages of the polymer of the invention are its optically active character and its reactivity. The chirality is carried particularly by the epoxide functions. The reactivity is linked to the presence of the epoxide functions within the polymeric skeleton. These properties of the polymer of the invention render it particularly appropriate for use in chiral chromatography, after opening of the reactive epoxide functions.

Preparatory or analytical chiral chromatography is making considerable progress by reason of the ever more severe constraints linked to regulations regarding medicaments and food supplements which oblige industrialists to propose pure enantiomers.

Chiral chromatography is particularly advantageous in so far as it permits the resolution of racemic mixtures in the case of molecules having a low molecular mass.

The chiral stationary phases developed industrially and known hitherto are in particular those described in Synlett, 1998, 4, 344-360 which are based on polysaccharides; those described in Angew. Chem. Int. Ed 1998, 37, 1020-1043 which are cellulose triacetates, cellulose benzoates, cellulose and amylose phenylcarbamates or cellulose aralkylcarbamates; also those described in High Resolution Chromatogr. 1998, 21, 261-281, which are silicas modified by bovine or human serum albumin, Pirkle type chiral phases or cyclodextrine or chiral phases modified by ring ethers.

The opening of the chiral epoxide functions of the polymer of the invention for the purpose of its use in chiral chromatography is carried out according to the invention by the action of a nucleophilic agent, optionally chiral, under conditions suitable for bringing about the opening of the epoxide functions. This opening reaction permits, if required, functionalisation of said polymer.

Examples of nucleophilic agents that can be used are phosphines, amines, guanidines, thiols and thiolates, ammonia, alcohols and alcoholates, water, selenols and their salts, sulphites and bisulphites and carbanions.

After the opening of the epoxide functions, the polymer of the invention is not only usable in chiral chromatography but also as a support in asymmetric solid phase synthesis or as chiral ligand capable of coordinating with a transition metal for the preparation of metallic complexes usable in asymmetric catalysis.

More precisely, the invention concerns an optically active polymer that can be obtained by radical or anionic polymerisation of an optically active ethylene monomer with epoxide function bearing at least one chiral centre, optionally in the presence of one or more other copolymerisable ethylene monomers.

By optically active polymer there is meant a polymer having an enantiomeric excess of at least 70%, preferably at least 75%, for example of at least 80% and even more preferably at least 90%, such as at least 95%.

The copolymerisable ethylene monomer may comprise one or more ethylene double bonds. When it comprises more than one ethylene double bond, it is preferable for these to be conjugated with one another.

Generally, the copolymerisable ethylene monomers comprise olefinic hydrocarbons such as styrene, α-methylstyrene, divinylbenzene, vinyltoluene, vinylfuran, vinylthiophene, vinylpyrrole and the styrenesulphonic acids, but also the dienes of the isoprene and butadiene type; halogenated monomers of the vinyl chloride type, chloroprene, vinylidene chloride, vinylidene fluoride and vinyl fluoride; unsaturated acids of the acrylic, methacrylic and crotonic acid type; unsaturated esters of the vinyl acetate, methyl methacrylate, ethyl acrylate, methyl actylate and 2-hydroxyethyl acrylate or methacrylate type; unsaturated amides such as acrylamide, N,N-dimethylacrylamide, methylenebisacrylamide and N-vinylpyrrolidone; unsaturated nitriles of the acrylonitrile type; unsaturated ethers such as vinyl and methyl ether; vinylpyridines, diethyl vinylphosphonate and sodium styrenesulphonate.

The preferred polymers of the invention are copolymers resulting from the polymerisation of a polymerisable ethylene monomer with an optically active ethylene monomer with epoxide function bearing at least one chiral centre.

Generally, the molar ratio of the fraction derived from the optically active ethylene monomer with epoxide functions to the fraction derived from the copolymerisable ethyelene monomer, in the polymer of the invention varies from 1-100:0-99, for example from 10-100:0-90, preferably from 30-100:0-70, preferred ratios being 100:0, 50:50 and 30:70.

According to a first preferred embodiment of the invention, each ethylene monomer comprises, at alpha of the ethylene double bond, a carbonyl, nitrile, ester, amide or ether function, this being for the purpose of increasing the reactivity thereof. More preferably, it is an ester function which activates the ethylene double bond.

Thus, a first preferred group of polymers of the invention consists of the polymers in which:

the copolymerisable ethylene monomers, when present, comprise a carbonyl, ester, amide or ether function at alpha of the ethylene double bond, and/or

the optically active ethylene monomer with epoxide function bearing at least one chiral centre comprises a carbonyl, ester or amide function at alpha of the ethylene double bond.

Among these polymers, those are preferred in which the optically active ethylene monomer with epoxide function has the formula I:

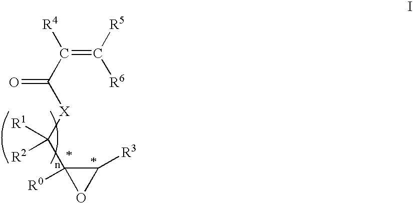

wherein:

* indicates the location of a carbon of well-determined R or S stereochemistry, it being understood that when R³ represents a hydrogen atom the carbon bearing R³ is not chiral;

n is an integer between 1 and 10, preferably selected from 1, 2, 3 and 4;

X represents —O—, —S— or —NT- where T represents a hydrogen atom; an alkyl, cycloalkyl or aryl group, said group being optionally substituted;

R⁰, R¹, R², R³, R⁴, R⁵ and R⁶ are independently selected from a hydrogen atom; or an alkyl, cycloalkyl or aryl group, said group being optionally substituted;

it being understood that R⁵ and R⁶ may further represent 1-alkenyl.

According to a preferred variant, X represents O in the above formula I.

Advantageously, in the formula I, R⁰ and R³ represent independently a hydrogen atom, an aryl group, optionally substituted, or an alkyl group, optionally substituted, R⁴ represents an alkyl group, optionally substituted, or an aryl group, optionally substituted, and R¹ and R² represent independently a hydrogen atom or an alkyl group, optionally substituted; and R⁵ and R⁶ are independently selected from a hydrogen atom, an alkyl group, optionally substituted, and an aryl group, optionally substituted.

Better still, in the formula I R⁰, R¹, R², R³, R⁵ and R⁶ represent a hydrogen atom; and R⁴ represents an alkyl group, optionally substituted, for example methyl.

As the preferred copolymer of the epoxide of formula I above, the copolymers obtained by polymerisation of said epoxide with a monomer of (meth)acrylate type are preferred.

By (meth)acrylate type monomer, there is meant within the framework of the invention a monomer of acrylate or methacrylate type, optionally substituted.

Preferred examples of (meth)acrylate monomers are the monomers of the formula:

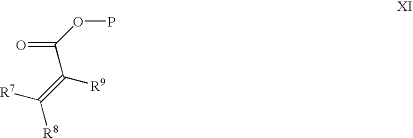

wherein R⁷, R⁸ and R⁹ represent independently a hydrogen atom; an alkyl group, optionally substituted an aryl group, optionally substituted; a cycloalkyl group, optionally substituted; or a polysiloxyl group; and P represents an alkyl group, optionally substituted, an aryl group, optionally substituted or a cycloalkyl group, optionally substituted, or O—P represents a polysiloxyl group.

By polysiloxyl group, there is meant according to the invention a polyorganosiloxane chain attached by an oxygen atom to the skeleton of the compound of formula XI and having in particular at least two different units selected from those of formula J₃SiO_{1/2} (unit M), J₂SiO (unit D), JSiO_{3/2} (unit T) and SiO_{4/2} (unit Q).

The radicals J are aliphatic or aromatic hydrocarbon radicals, optionally substituted, of the alkyl type, linear or branched, C₁-C₁₈, or (C₆-C₁₈) aryl, it being understood that one or more of the radicals J in said polyorganosiloxane chain may further represent a hydrogen atom or a hydroxyl group.

As the type of preferred polyorganosiloxane chains, those preferred are those coming from polyorganosiloxane of formula XII:

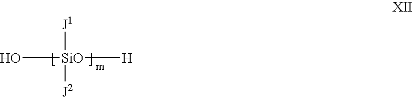

wherein:

m is an integer above or equal to 2, preferably above or equal to 10 and J¹ and J² are such as defined above for J, it being understood that J¹ or/and J² may further represent a hydrogen atom or a hydroxyl group.

More particularly, in the formula XII above, it is preferred that J¹ and/or J² represents (C₁-C₆)alkyl, advantageously methyl.

Another preferred sub-group of polymers of the invention consists of copolymers that can be obtained by polymerisation of an optically active monomer with epoxide functions with a copolymerisable ethylene monomer comprising two ethylene double bonds each having a carbonyl, ester or amide group at alpha of the double bond.

Among this other group of polymers, those which are distinguished more particularly are those consisting of the following two types of repeat units A and B, of the formula:

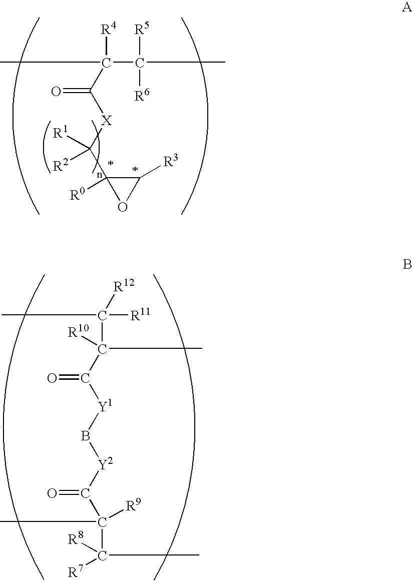

the unit A bearing at least one optically active chiral centre at the epoxide function;

wherein:

indicates the location of a carbon of well-determined R or S stereochemistry, it being understood that when R³ represents a hydrogen atom the carbon bearing R³ is not chiral;

n is an integer between 1 and 10, preferably selected from 1, 2, 3 and 4;

X, Y¹ and Y² are independently selected from —O—, —S— and —NT- where T represents a hydrogen atom, an alkyl, cycloalkyl or aryl group, said group being optionally substituted

B represents a divalent radical selected from alkylene; cycloalkylene; alkylene interrupted by one or more arylene or/and cycloalkylene groups; or arylene; each of the alkylene, cycloalkylene or arylene groups being optionally substituted

R⁰, R¹, R², R³, R⁴, R⁵, R⁶, R⁷, R⁸, R⁹, R¹⁰, R¹¹ and R¹² are independently selected from a hydrogen atom, an alkyl, cycloalkyl or aryl group, said group being optionally substituted;

R⁷, R⁸, R⁹, R⁹, R¹⁰, R¹¹ and R¹² represent independently alkoxy, optionally substituted, aryloxy, optionally substituted, alkylcarbonyloxy, optionally substituted, or arylcarbonyloxy, optionally substituted

it being understood that R⁵, R⁶, R⁷, R⁸, R¹¹ and R¹² may further represent 1-alkenyl, and that R⁷, R⁸ and R⁹ may further represent a polysiloxyl group.

Within the framework of the invention, there is meant by 1-alkenyl an aliphatic hydrocarbon group comprising at least one double bond at position 1, and optionally one or more other double bonds conjugated with the first.

Preferably, 1-alkenyl is C₁-C₁₀.

Within the framework of the invention, there is meant by alkyl a linear or branched saturated hydrocarbon radical such as methyl, ethyl, propyl, isopropyl, butyl, isobutyl, t-butyl, pentyl, isopentyl, neopentyl, 2-methylbutyl, 1-ethylpropyl, hexyl, isohexyl, neohexyl, 1-methylpentyl, 3-methylpentyl, 1,1-dimethylbutyl, 1,3-dimethylbutyl, 2-ethylbutyl; 1-methyl-1-ethylpropyl.

Preferably, the alkyl radical comprises 1 to 10 carbon atoms, better still 1 to 6 carbon atoms, more preferably 1 to 4 carbon atoms.

By aryl, there is meant a monocyclic or polycyclic hydrocarbon aromatic radical. When said aryl radical is polycyclic, each of the monocyclic nuclei constituting it is an aromatic hydrocarbon radical. In this case, said monocyclic nuclei are either attached to one another by single carbon-carbon bonds, or are orthocondensed or pericondensed.

Advantageously, the aryl radicals have from 6 to 18 carbon atoms, better still from 6 to 10 carbon atoms. Examples of aryl groups are in particular phenyl, naphthyl, anthryl or phenanthryl.

By cycloalkyl there is meant, according to the invention, monocyclic or polycyclic saturated hydrocarbon radicals. When the cycloalkyl group is polycyclic, it consists of a plurality of saturated hydrocarbon monocyclic nuclei, attached to one another by single carbon-carbon bonds or/and monocyclic nuclei having two by two at least two carbon atoms in common.

Advantageously, the cycloalkyl group is C₃-C₁₁ such as cyclobutyl, cyclopentyl, cyclohexyl, cycloheptyl, cyclooctyl, adamantyl and norbornyl.

The expression “alkylene interrupted by one or more arylene and/or cycloalkylene groups” means that B may represent any one of the following chain formations:

-alk¹-T^{o}-alk²-;

-alk¹-T^{o}- ; or

-T^{o}-alk¹;

where T^{o} represents arylene or cycloalkylene, and alk¹, alk² represent independently alkylene of identical or different size.

The substituents of the alkyl, cycloalkyl, aryl, cycloalkylene, alkylene or arylene radicals are any whatsoever on condition that they are inert *under the conditions of radical polymerisation employed for the preparation of said polymer.

Thus, the substituents in question have no function capable of reacting with the constituents of the reaction medium, or capable of preventing the radical reactions utilized for the preparation of the polymer of the invention.

Examples of the substituents to be banned are bromine and iodine atoms, and nitro groups when these atoms and groups are carried by sp³ carbons.

Similarly, the substituents coming from compounds that can be used as free radical traps are to be proscribed: examples thereof are the substituents derived from hydroquinone, monotertiobutylhydroquinone, 2,5-ditertiobutylhydroquinone, paratertiobutylcatechol, parabenzoquinone or ditertiobutylparacresol.

By way of example of suitable substituents there may be mentioned chlorine and fluorine atoms; alkyl radicals; perfluoroalkyl (and for example trifluoromethyl); aryl; perfluoroaryl; cycloalkyl; perfluorocycloalkyl; alkoxy; aryloxy; cycloalkyloxy; oxo; cyano; amino disubstituted by alkyl, aryl or/and cycloalkyl; —CONR^{a}R^{b} wherein R^{a} and R^{b} are independently selected from H, alkyl, aryl and cycloalkyl, it being understood that R^{a} and R^{b} do not both represent a hydrogen atom; and —COOR^{c} where R^{c} is such as defined above for R^{a}. Other acceptable substituents are the hydroxy groups and the polyoxyalkylene chains of the type of polyoxyethylene chains having a degree of polymerisation from 2 to 20. The bromine atoms may also be selected as substituents on condition that they are carried by sp² carbon atoms.

When T or one of R⁰ to R¹² represents substituted alkyl, the latter may represent a C₁-C₁₀ linear alkyl (preferably C₁-C₅ linear alkyl, for example methyl) substituted in the ω position by a radical selected from perfluoroalkyl (especially (C₁-C₁₀)perfluoroalkyl; perfluoroaryl (especially C₆-C₁₈)perfluoroaryl); perfluorocycloalkyl (especially C₃-C₁₁)perfluorocycloalkyl); and a polyoxyalkylene chain such as a polyoxyethylene chain.

When B represents substituted alkylene, the latter may represent C₁-C₁₀ linear alkylene substituted by one or more fluorine atoms and, for example, perfluorinated alkylene.

Preferred meanings of X, Y¹ and Y² are an oxygen atom.

Preferably, B represents alkylene, optionally substituted, preferably ethylene.

In the unit A, R⁰ and R³ represent independently preferably a hydrogen atom, an aryl group, optionally substituted, or an alkyl group, optionally substituted; R⁴ preferably represents alkyl, optionally substituted, or an aryl group, optionally substituted; and R¹ and R² are preferably independently selected from a hydrogen atom, an alkyl group, optionally substituted, or an aryl group, optionally substituted; and R⁵ and R⁶ are preferably independently selected from a hydrogen atom, an alkyl group, optionally substituted, and an aryl group, optionally substituted.

In the unit B, it is preferred that R⁹ and R¹⁰ are independently selected from alkyl, optionally substituted, and an aryl group, optionally substituted, and that R⁷, R⁸, R¹¹ and R¹² represent independently a hydrogen atom, an alkyl group, optionally substituted, or an aryl group, optionally substituted.

Among the preferred polymers above consisting of the units A and B, it is preferred that R⁰, R¹, R², R⁵, R⁶, R⁷, R⁸, R¹¹ and R¹² represent a hydrogen atom; and R⁴, R⁹ and R¹⁰ represent a methyl group; and R³ represents H, methyl or phenyl.

According to another preferred embodiment of the invention, the optically active polymer is prepared starting from an ethylene monomer with epoxide function comprising a carbonyl, ester, amide or ether function at alpha of the ethylene double bond and from a copolymerisable monomer-comprising at least two ethylene double bonds. Preferably, each ethylene double bond of the copolymerisable monomer is grafted on an alkylene or arylene group.

Among these polymers, there is distinguished a second preferred group of the polymers of the invention, which consists of the polymers composed of the two following repeat units A and C of the formulae:

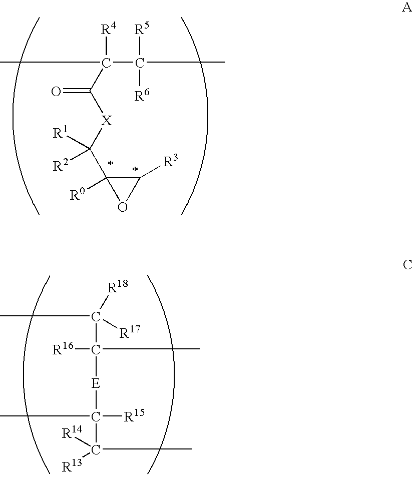

the unit A bearing at least one optically active chiral centre at the epoxide function;

wherein:

* indicates the optional location of a carbon of well-determined R or S stereochemistry, it being understood that when R³ represents a hydrogen atom the carbon bearing R³ is not chiral;

n is an integer between 1 and 10, preferably selected from 1, 2, 3 and 4;

x is selected from —O—, —S— and —NT- where T represents a hydrogen atom, an alkyl, cycloalkyl or aryl group, said group being optionally substituted;

E is selected from alkylene, optionally substituted, and optionally interrupted by one or more divalent groups —Si(A) (B)- where A and B are independently selected from alkyl, optionally substituted, or aryl, optionally substituted ; the divalent group of formula -Ch¹-Ar^{o}-Ch²- where Ch¹, Ch² represent independently a bond, an oxygen atom, a sulphur atom or —NT-, T being such as defined above and Ar^{o} represents arylene, optionally substituted; a bond; an oxygen atom; the divalent group —NT- in which T represents a hydrogen atom, an alkyl group, optionally substituted, or an aryl group, optionally substituted; or an —Ar¹—X¹-alk-X²—Ar²— chain where Ar¹ and Ar² are independently selected from arylene, optionally substituted alk represents alkylene, optionally substituted, and X¹, X² represent independently O or —NT^{o} -, T^{o} being such as defined above for T;

R⁰, R¹, R², R³, R⁴, R⁵, R⁶, R¹³, R¹⁴, R¹⁵, R¹⁶, R¹⁷ and R¹⁸ are independently selected from a hydrogen atom, an alkyl, cycloalkyl or aryl group, said group being optionally substituted;

R¹³, R¹⁴, R¹⁵, R¹⁶, R¹⁷ and R¹⁸ may further represent alkoxy, optionally substituted; aryloxy, optionally substituted; alkylcarbonyloxy, optionally substituted; arylcarbonyloxy, optionally substituted; or a polysiloxyl group;

it being understood that R⁵, R⁶, R¹³, R¹⁴, R¹⁷ and R¹⁸ may further represent 1-alkenyl, and R¹³, R¹⁴ and R¹⁵ may further represent a polysiloxyl group.

The substituents of the alkyl, cycloalkyl, aryl, alkylene and arylene groups are as defined above.

Similarly, the alkyl, cycloalkyl, aryl, alkylene and arylene radicals are as defined above. Polysiloxyl is also as defined above.

Preferably:

when E represents alkylene, optionally substituted, it represents —(CH₂)n′- where n′ is an integer between 1 and 10, such as 1, 2, 3, 4 or 5;

when E represents arylene, optionally substituted, it represents phenylene, optionally substituted

when E represents alkylene interrupted by —Si(A) (B)-, it represents the group (CH₂)ₙ₁ —Si (A) (B)-(CH₂)ₙ₂— where n₁ and n₂ are independently an integer from 0 to 10, preferably 0, 1, 2, 3, 4 or 5 and A, B are as defined above;

when E represents —Ar¹—X¹-alk-X²—Ar²—, it represents the group:

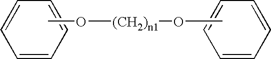

where n¹ is as defined above; more particularly in this radical it is preferred that the phenyl groups are distributed in para position.

It must be understood that the terms alkyl, cycloalkyl, aryl, arylene, alkenyl and polysiloxyl are as defined above for the repeat units A and B.

Among this preferred group of compounds, those are more particularly preferred which in addition fulfil one or more of the following conditions i) to iii):

i) X represents an oxygen atom;

ii) R⁰ and R³ represent independently a hydrogen atom; an aryl group, optionally substituted; an alkyl group, optionally substituted; R⁴ represents alkyl, optionally substituted, or an aryl group, optionally substituted and R¹ and R² are independently selected from a hydrogen atom, an alkyl group, optionally substituted ; or an aryl group, optionally substituted; and R⁵ and R⁶ are independently selected from a hydrogen atom, an alkyl group, optionally substituted, and an aryl group, optionally substituted.

iii) R⁰, R¹, R², R⁵, R⁶, R¹⁴, R¹⁵, R¹⁶, R¹⁷ and R¹⁸ represent a hydrogen atom; E represents phenylene; n is 1; X represents an oxygen atom; R⁴ represents methyl; and R³ represents a hydrogen atom or a phenyl group.

The invention moreover concerns a method for preparing the optically active polymer of the invention. This method comprises the radical or anionic polymerisation of an optically active monomer with epoxide function bearing at least one chiral centre, if necessary in the presence of one or more other copolymerisable ethylene monomers, the polymerisation being conducted in the presence of a radical or anionic initiator.

When polymerisation of the monomers is carried out radically, the polymerisation is initiated by thermoactivation of an appropriate initiator, preferably of the azoic or peroxide type.

As initiator of the azoic type, there may be mentioned 1,1¹-azobis(isobutyronitrile) or azobisiso-butyronitrile (AIBN); 1,1¹-azobis(secpentylnitrile); 1,1¹-azobis(cyclohexanecarbonitrile); or phenylazotri-phenylmethane.

Other radical polymerisation initiators that can be used within the framework of the invention are benzopinacol (1,1,2,2-tetraphenyl-1,2-ethanediol), 1,1,2,2-tetraphenyl-1,2-dicyanoethane, 1,1,2,2-tetraphenyl-1,2-diphenoxyethane and 1,1,2,2-tetraphenyl-1,2-bis(trimethylsilyloxy)ethane.

More particularly advantageously, the initiator is AIBN.

By way of examples of initiators or the peroxide type, there will be mentioned benzoyl peroxide, tertiobutyl peroxide, sec-butyl peroxide, n-butyl peroxide, acetyl peroxide, lauryl peroxide, vinyl peroxide, tert-butyl peracetate, tert-butyl hydroperoxide, cumene hydroperoxide, 2,4-dichlorobenzoyl peroxide, tert-butyl perbenzoate, 1,1-bis(tert-butyl)-3,3,5-trimethylcyclohexane peroxide. The use of benzoyl peroxide is illustrated particularly in M. TANG, Process Biochemistry, vol. 34, 1999, 857.

As a variant, any one of the following initiators may be used:

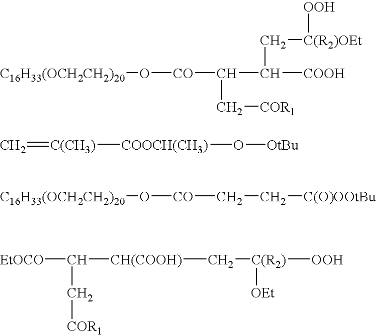

where R₁ and R₂ are selected from H and CH₃.

Among these peroxides, benzoyl peroxide is preferred.

The radical polymerisation reaction is carried out at a temperature sufficient to initiate the radical polymeristion or at a higher temperature. This temperature depends in particular on the type of initiator used. Generally, a temperature ranging between 50 and 150° C., better still between 60 and 110° C., especially between 50 and 100° C., for example between 70 and 90° C.

As a variant, polymerisation is carried out anionically in the presence of a stabilizer of the active centre of the polymerisation selected from tertio-alcoholates of alkaline metals; halides of alkaline metals; polydentate alcohols of alkaline metals; and alkylaluminiums.

The tertio-alcoholates of alkaline metals are the alcoholates derived from the corresponding aliphatic alcohols in which the hydroxy function is attached to a tertiary alkyl radical; examples thereof are lithium tert-butylate; sodium tert-butylate; potassium tert-butylate; and lithium 3-methyl-3-pentylate.

As a particularly appropriate alkaline metal halide, lithium chloride may be mentioned.

The polydentate alcoholates of alkaline metals are the alcoholates having one or more electronegative atoms selected from O, S and N, and more particularly selected from O and N.

Examples thereof are in particular lithium 2-(2-methoxyethoxy)ethylate; or any one of the compounds of formula:

CH₃O—(CH₂—CH₂—O)₂—Li;

CH₃O—CH₂—CH₂—O—Li;

CH₃O—(CH₂—CH(CH₃)O)₂—Li;

(CH₃)₂N—(CH₂—CH₂—O)₂—Li; or

(CH₃)₂N—CH₂—CH₂—O—Li.

The alkylaluminiums of formula AIE¹E²E³ in which E¹, E² and E³ represent independently alkyl, optionally substituted by alkoxy; or aryl, optionally substituted by alkyl or alkoxy; alkoxy, optionally substituted by alkyl; or aryloxy, optionally substituted by alkyl or alkoxy.

The alkyl, alkoxy or aryl radicals are as defined above.

Examples of alkylaluminium are in particular triethylaluminium, and the compounds of the formula:

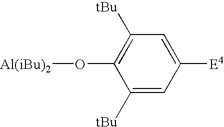

wherein E⁴ represents H or CH₃.

Preferably, the stabilizer is selected from lithium chloride; lithium tertbutylate; and lithium 3-methyl-3-pentylate, the most particularly preferred stabilizer being lithium chloride.

According to a preferred embodiment, the anionic polymerisation is carried out by further incorporating in the reaction medium a polymerisation initiator selected from alkyllithium; ester enolates of alkaline metals; and primary and secondary alcoholates of alkaline metals.

The alkyllithiums designate saturated or unsaturated aliphatic hydrocarbons in which one or more of the hydrogen atoms are replaced by lithium atoms. By aliphatic hydrocarbon there is meant more particularly a linear or branched chain aliphatic saturated hydrocarbon substituted, if required, by one or more radicals selected from alkoxy or aryl, itself substituted, if required, by alkyl or alkoxy.

Examples of such alkyllithiums are monolithiated alkyllithiums selected from n-butyllithium, tert-butyllithium, 1,1-diphenylhexyllithium, diphenylmethyllithium, 1,1-diphenyl-3-methylpentyllithium and β-lithio-α-methylstyrene.

Other examples of alkyllithium are the dilithiated alkyllithiums such as 1,1,4,4-tetraphenyl-1,4-dilithiobutane or 1,3-bis(2-lithio-2-isopropyl)benzene.

The ester enolates of alkaline metals are ester enolates derived from alkylcarboxylic acids and from lower alkanols.

Said alkylcarboxylic acids- have a linear or branched alkyl radical such as defined above bearing one or more carboxy groups: this alkyl radical is further optionally substituted by one or more aryl radicals, themselves optionally substituted by alkyl or alkoxy.

Said lower alkanols correspond to the formula G-OH where G represents a linear or branched alkyl group as defined above and is optionally substituted by one or more aryl radicals, themselves optionally substituted by alkyl or alkoxy.

Examples of enolates of esters of alkaline metals are tert-butyl 2-lithioisobutyrate, methyl 2-lithioisobutyrate or its sodium-containing equivalent, ethyl 2-lithioisobutyrate or its potassium-containing equivalent, dimethyl 2-lithio-2,2,4-trimethylglutarate, ditert-butyl 2-lithio-2,2,4-trimethylglutarate; isopropyl 2-lithio-isobutyrate: and tert-butyl 2-sodio-propionate.

The primary and secondary alcoholates of alkaline metals are the alcoholates derived from the corresponding aliphatic alcohols in which the hydroxy function is attached to a secondary or primary alkyl radical. Preferred examples thereof are lithium methylate, lithium ethylate and lithium propylate.

Particularly advantageously, the initiator is selected from sec-butyllithium, diphenylmethyllithium and 1,1,4,4-tetraphenyl-1,4-dilithiobutane.

According to a first preferred embodiment of the invention, a monomer of formula I such as defined above is polymerised:

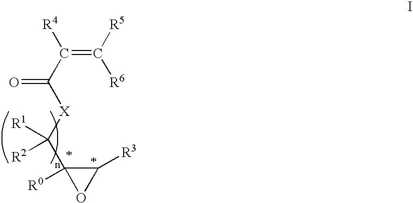

where R⁰, R¹, R², R³, R⁴, R⁵, R⁶, * and n are as defined above.

Advantageously, said monomer of formula I is copolymerised with a monomer of formula XI

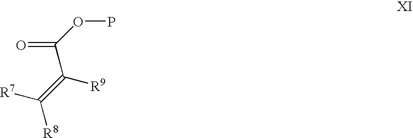

wherein R⁷, R⁸, R⁹ and P are as defined above.

Still more preferably, the method of the invention comprises the reaction of an optically active monomer with epoxide function of formula I, in which:

* indicates the location of a carbon of well-determined R or S stereochemistry, it being understood that when R³ represents a hydrogen atom the carbon bearing R³ is not chiral;

n is an integer between 1 and 10, preferably selected from 1, 2, 3 and 4;

X represents —O—, —S— or —NT- where T represents a hydrogen atom; an alkyl, cycloalkyl or aryl group, said group being optionally substituted

R⁰, R¹, R², R³, R⁴, R⁵ and R⁶ are independently selected from a hydrogen atom; an alkyl, cycloalkyl or aryl group, said group being optionally substituted;

it being understood that R⁵ and R⁶ may further represent 1-alkenyl;

with a copolymerisable monomer of formula II

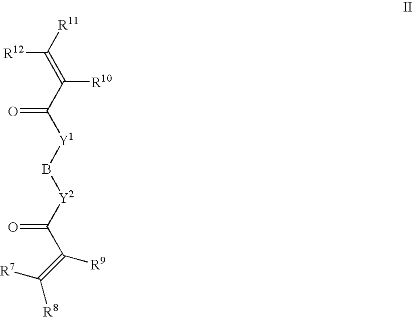

wherein:

Y¹, Y² represents —O—, —S— or —NT- where T represents a hydrogen atom, an alkyl, cycloalkyl or aryl group, said group being optionally substituted;

B represents alkylene, cycloalkylene, arylene or alkylene interrupted by one or more arylene and/or cycloalklyene groups; each alkylene, cycloalkylene or arylene being optionally substituted;

R⁷, R⁸, R⁹, R¹⁰, R¹¹ and R¹² are independently selected from a hydrogen atom, an alkyl, cycloalkyl, aryl, alkoxy, aryloxy, alkylcarbonyloxy or arylcarbonyloxy group, said group being optionally substituted;

it being understood that R⁷, R⁸, R¹¹ and R¹² may further represent 1-alkenyl, and R⁷, R⁸ and R⁹ may further represent a polysiloxyl group.

In the formulae I and II, 1-alkenyl is such as defined above for the copolymer.

According to a preferred embodiment, X represents O; Y¹, Y² both represent an oxygen atom and B represents an alkylene, optionally substituted, or an arylene group, optionally substituted.

Advantageously, in formula I, R⁰ and R³ represent a hydrogen atom, an aryl group, optionally substituted, an alkyl group, optionally substituted, R⁴ represents alkyl, optionally substituted, or an aryl group, optionally substituted, and R¹ and R² represent independently a hydrogen atom, an alkyl group, optionally substituted, or an aryl group, optionally substituted ; and R⁵ and R⁶ are independently selected from a hydrogen atom, an alkyl group, optionally substituted, and an aryl group, optionally substituted.

Moreover, in formula II, it is preferred that R⁹ and R¹⁰ are independently selected from akly, optionally substituted, and an aryl group, optionally substituted, and R⁷, R⁸, R¹¹ and R¹² represent independently a hydrogen atom, an alkyl group, optionally substituted, or an aryl group, optionally substituted.

Better still, in formula I, R⁰, R¹, R², R⁵ and R⁶ represent a hydrogen atom; R⁴ represents alkyl, optionally substituted, and in formula II, R⁷, R⁸, R¹¹, R¹² are hydrogen atoms and R⁹ and R¹⁰ represent a methyl group; R³ represents H, a methyl group or a phenyl group.

According to a second preferred embodiment of the invention, a monomer of formula I as defined above is polymerised with a copolymerisable monomer of formula III:

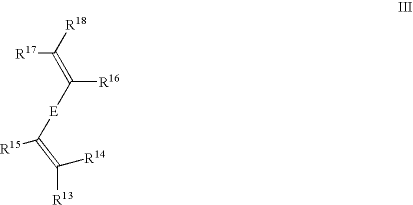

wherein

E is selected from alkylene, optionally substituted, and optionally interrupted by one or more divalent groups —Si (A) (B)- where A and B are independently selected from alkyl, optionally substituted, or aryl, optionally substituted ; the divalent group of formula -Ch¹-Ar^{o}-Ch² - where Ch¹, Ch² represent independently a bond, an oxygen atom, a sulphur atom or —NT-, T being such as defined above; and Ar^{o} represents arylene, optionally substituted; a bond; an oxygen atom; the divalent group —NT- in which T represents a hydrogen atom, an alkyl group, optionally substituted, or an aryl group, optionally substituted; or an —Ar¹X¹alk-X²—Ar²— chain where Ar¹ and Ar² are independently selected from arylene, optionally substituted, alk represents alkylene, optionally substituted, and X, X² represent independently O or —NT^{o}-, T^{o} being such as defined above for T;

R¹³, R¹⁴, R¹⁵, R¹⁶, R¹⁷ and R¹⁸ are independently selected from a hydrogen atom, an alkyl, cycloalkyl or aryl alkoxy, aryloxy, alkylcarbonyloxy or arylcarbonyloxy group, said group being optionally substituted;

it being understood that R¹³, R¹⁴, R¹⁷ and R¹⁸ may further represent 1-alkenyl, and R¹³, R¹⁴ and R¹⁵ may further represent a polysiloxyl group.

Preferably, the monomers I and/or III fulfil one or more of the following conditions iv) and vi):

iv) R^{o} and R³ represent independently a hydrogen atom, an aryl group, optionally substituted, an alkyl group, optionally substituted, R⁴ represents alkyl, optionally substituted, or an aryl group, optionally substituted, and R¹ and R² represent independently a hydrogen atom or an alkyl group, optionally substituted; and R⁵ and R⁶ are independently selected from a hydrogen atom, an alkyl group, optionally substituted, and an aryl group, optionally substituted.

v) R¹⁵ and R¹⁶ are independently selected from alkyl, optionally substituted, aryl, optionally substituted, and a hydrogen atom; and R¹³, R¹⁴, R¹⁷ and R¹⁸ represent independently a hydrogen atom, an alkyl group, optionally substituted, or an aryl group, optionally substituted.

vi) R⁰, R¹, R², R⁵ and R⁶ represent a hydrogen atom; R⁴ represents alkyl, optionally substituted, and R³ represents H or phenyl, and in formula III, R¹³, R¹⁴, R¹⁷ and R¹⁸ are hydrogen atoms; R¹⁵ and R¹⁶ represent a methyl group, a phenyl group or a hydrogen atom.

vii) X represents an oxygen atom;

According to another particularly preferred embodiment, the compound of formula I is glycidyl methacrylate and the compound of formula III is a divinylbenzene, for example 1,4-divinylbenzene.

Examples of preferred monomers III are:

2-[(N-benzyl-N-methylamino)methyl]-1,3-butadiene;

N,N-diallylaniline;

2,3-bis(4-ethoxy-4-oxobutyl)-1,3-butadiene;

3,7-dimethylocta-1,6-diene.

The radical polymerisation reaction is advantageously conducted in a biphase medium comprising water and a polar organic solvent to which is added a very hydrophilic polar compound, the purpose of which is to form stable disperse systems of the suspension or emulsion type. When polymerisation is carried out in suspension, this compound will be selected from protective colloids such as polyvinylpyrrolidone, polyvinyl alcohols and their ethers, polyethylene glycols and their ethers, polyvinylacetates, polyvinylacetamides, gelatin, methyl cellulose, polymethacrylamides, salts of polymethacrylic acid or the acid itself, or phosphates of alkaline earth metals. When polymerisation is carried out in emulsion, this compound will be selected from a polymer resulting from the polymerisation of one of the following monomers with ethylene double bond:

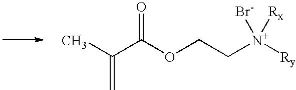

where Rₓ and R_{y} represent independently hydrocarbyl, it being understood that at least one of Rₓ or R_{y} is a fatty hydrocarbyl, having from 8 to 24 carbon atoms. Preferably, Rₓ and R_{y} are C₁-C₂₄ alkyl, better still Rₓ=CH₃ and R_{y}=dodecyl;

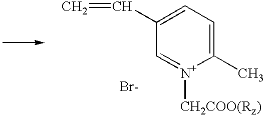

where R_{z} is such as defined above for Rₓ and has from 8 to 24 carbon atoms; preferably R_{z} represents C₁₀H₂₃;

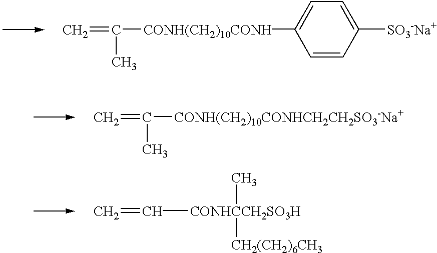

The polymers usable for radical polymerisation in emulsion and those usable for polmerisation in suspension are respectively described in particular in chapters 6, page 248 and 7, page 290, of “Radical polymerisation in disperse system”, J. Barton and I. Capek (Eds), Ellis Horwood series in polymer chemistry, 1994.

Preferably, polyvinylpyrrolidone will be selected to form a disperse system appropriate for polymerisation in suspension.

In all cases, the polar organic solvent associated with water may be selected from aromatic hydrocarbons, optionally substituted, aliphatic hydrocarbons, halogenated or not, ketones, amides, esters, pyridine, propylene carbonate, cyclic ethers or C₄-C₈ cycloalkanols or C₁-C₁₈ alkanols, without excluding the possibility of using mixtures of solvents.

The aromatic hydrocarbons are optionally substituted and may be selected from benzene; xylenes; toluene, ethylbenzene; fluoro-, chloro- and bromobenzene; cumene; anisol; benzonitrile; and N,N-dimethylaniline.

As aliphatic hydrocarbon, hexane, heptane, ligroine or petroleum ether may be mentioned.

Halogenated aliphatic. hydrocarbons usable as solvent are in particular methylene chloride, chloroform, carbon tetrachloride and dichloroethane, more preferably carbon tetrachloride and dichloromethane.

Ketones suitable as solvent are in particular acetone, methylethylketone, methylisobutylketone, isophorone or cyclohexanone.

The amides usable as solvent are for example formamide, dimethylformamide, dimethylacetamide, N-methyl-2-pyrrolidinone, hexamethylphosphorylamide or N-methylpropionamide, the latter being more particularly preferred.

As ester, methyl acetate will be used, for example, or better still, butyl acetate.

The cyclic ethers that can be considered are in particular tetrahydrofuran and dioxan, dioxan being preferred.

The preferred C₁-C₁₈ alkanols are for example methanol, ethanol, propanol, isopropanol, butanol, isobutanol and t-butanol.

As cycloalkanol, cyclohexanol is preferred.

On the other hand, according to another embodiment, liquefied or supercritical CO₂ may be substituted for the association of the polar organic solvent and water.

When liquefied or supercritical CO₂ is used as solvent for polymerisation, suitable operating conditions are a pressure of from 5 to 40 MPa, preferably from 10 to 35 MPa and a temperature ranging between 30 and 110° C.

In order best to determine the operating conditions for radical polymerisation, an expert in the field may take inspiration from the following three publications:

Macromol. Chem. Phys., 2000, 201, No. 13, 1532-1539;

Journal of Polymer Science, Part A : Polymer Chemistry, vol. 38, 3783-3790, 2000;

Macromolecules, 2000, 33, 6757-6763.

However, the invention is not limited to these embodiments and also comprises the methods in which radical polymerisation is carried out without solvent or in a monophase medium. In this case also, the solvent is selected from aromatic hydrocarbons, optionally substituted, aliphatic hydrocarbons, halogenated or not, ketones, amides, pyridine, propylene carbonate, cyclic ethers, C₄-C₈ cycloalkanols or C₁-C₁₈ alkanols, without excluding the possibility of using mixtures of solvents.

Radical polymerisation in suspension in a biphase water/organic solvent medium is particularly favourable if it is wished to obtain a polymer in the form of porous balls, this being particularly advantageous in the case of certain applications such as solid phase synthesis, immobilising enzymes and chiral chromatography.

On the other hand, for the purpose of adapting the physical and physico-chemical properties of the polymer balls (such as appearance, porosity, specific surface area, the size of the balls and the resistance), it is to be recommended to add additives or cosolvents to the reaction medium of the radical polymerisation. The size will for example depend on the quantity and the nature of the additive used.

More particularly, for the purpose of improving the porosity properties of the polymer balls, it is recommended to add to the reaction medium a C₅-C₈ cycloalkyl alcohol on the one hand and a C₁-C₁₈ alkanol on the other hand, these latter functioning as porogenic solvents.

The cycloalkyl alcohol is generally an alcohol capable of dissolving the polymer, such as cyclohexanol.

The C₁-C₁₈ alcohol is selected in particular from dodecanol, lauryl alcohol, methanol, ethanol, propanol, butanol, octanol, decanol, tetradecanol or hexadecanol. Advantageously, the C₁-C₁₈ alcohol is dodecanol or lauryl alcohol.

As the preferred porogenic medium, a mixture of cyclohexanol and dodecanol will be used, or a mixture of cyclohexanol and lauryl alcohol.

In order to control the parameters of the macroporous structure of the polymers of the invention, such as the specific surface area of the balls, their diameter, the porous volume, the resistance to heat, the resistance to alkaline solutions, the dynamic capacity, the selectivity, the balancing rate and the content of epoxy groups, it is also possible to adjust the speed of agitation of the reaction medium, the concentrations of the different reagents in the medium, the temperature and the polymerisation times.

For adequate adaptation of the reaction conditions, an expert in the field will refer for example to one or more of the following publications:

Biotechnology and bioengineering, vol. 48, No. 5(5), 1995, 476-480;

Angew. Makromol. Chem. 1975, 708, 135-143;

Angew. Makromol. Chem. 1981, 95, 109-115;

Materials Science Forum, 214, 1996, 155-162; and

Angew. Makromol. Chem. 1981, 95, 117-127.

Anionic polymerisation is generally carried out in a monophase organic solvent selected from aliphatic, cyclic, saturated or aromatic hydrocarbons; ethers, pyridine and mixtures thereof.

Generally, the hydrocarbons are hexane, heptane, benzene, toluene or xylenes.

Among the preferred hydrocarbons, heptane, cyclohexane or toluene will be selected.

The ethers usable as solvents are for example diethyl ether, diisopropyl ether, tetrahydrofuran or dioxan, diethyl ether and tetrahydrofuran being preferred.

Particularly suitable mixtures of these solvents are the toluene/tetrahydrofuran mixture and the cyclohexane/diethyl ether mixture.

The anionic polymerisation temperature generally ranges between −100° C. and 0° C., preferably between −60° C. and −30° C., better still between −50° C. and −35° C.

For fuller information on the operating conditions suitable for carrying out anionic polymerisation, an expert in the field is invited to refer to the following documents:

G. Hild, J. P. Lamps, Polymer, vol 36, 1995, 4841; and

Prog. Polym. Sci. 24 (1999) 793-873. P. Vicek, L. Lochmann.

The compounds of formula I and II in racemic form are commercially available, or easily prepared by an expert in the field by the use of conventional methods of organic chemistry.

The optically active compounds of formula I may be prepared starting from corresponding racemic mixtures either by chemical resolution, or by enzymatic resolution, or by chiral chromatography.

For enzymatic resolution, an expert in the field may draw inspiration from the work of W. E. Ladner, G. M. Whitesides described in J. Am. Chem. Soc. 1984, 106, 7250-7251.

The principle of the method illustrated in this document rests on the selectivity of the enzyme used, a lipase, for the hydrolysis of esters of epoxidated alcohols. Only one of the enantiomers of the ester to be hydrolysed is attacked by the lipase such that at the outcome of the hydrolysis reaction, an optically active alcohol is isolated and one of the enantiomers of the starting ester, that which is not attacked by the lipase.

The conditions of the hydrolysis reaction will be easily determined by an expert in the field according to the enzyme used.

Generally, the reaction is conducted in an aqueous medium with control of the pH of the reaction medium.

Schematically, when X═O and n=1 in the compound of formula I, the reaction may be represented as follows:

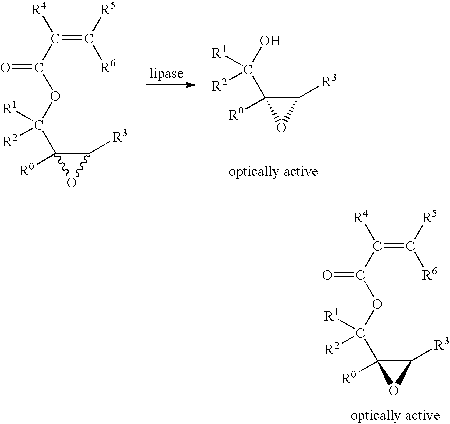

Although in the preceding diagram the chirality of each of the products obtained may have been indicated, it should be understood that this chirality may be inverted, the only constant being that the enantiomer ester has the opposite configuration to that of the ester effectively hydrolysed by the lipase.

As a variant, and for the purpose of effecting the catalytic resolution of the racemic of the compounds of formula I, an expert in the field may refer to the work of M. Tokunaga, J. F. Lanow, F. Kakiuchi, E. N. Jacobsen, Science, 1997, 277, 936-938.

This publication illustrates in particular the stereoselective hydrolysis of the epoxide function of the ester of formula I. The stereoselectivity results from the incorporation in the reaction medium of a catalyst, metallic complex of cobalt, which catalyses the hydrolysis reaction of only one of the enantiomers of the racemic mixture of the ester of formula I.

The catalyst (Cat.) exemplified in this publication has the formula:

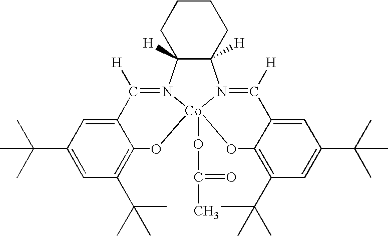

The hydrolysis reaction of the epoxide function of an ester of formula I in which X═O may be schematised as follows:

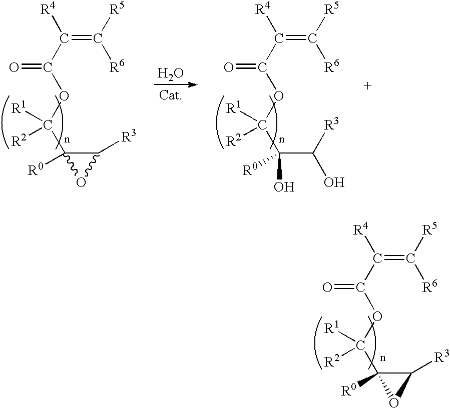

There again, the chirality of each of the products obtained as represented in the preceding diagram could be inverted, the essential thing being that the enantiomer of formula I isolated has a configuration opposed to that of the enantiomer hydrolysed.

Another variant consists in synthesizing diastereoselectively the optically active epoxide of formula I.

In order so to do, an expert in the field may draw inspiration from the known methods.

When X represents O, an expert in the field may prepare the compounds of formula I by reaction of the corresponding, optically pure, epoxidated alcohol, of formula VIII:

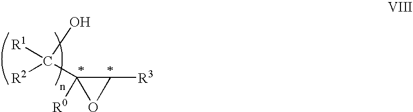

wherein n, R⁰ to R³ and * are as defined above for formula I, on the appropriate acid of formula IX:

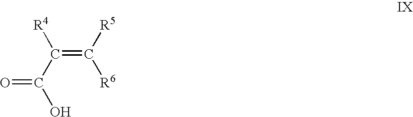

wherein R⁴ to R⁶ are as defined above for formula I, or an activated form of the latter, under gentle esterification conditions and preferably in a basic or neutral medium.

When an acid of formula IX with free —COOH function is used, it is desirable to carry out esterification in the presence of a condensation agent such as, for example, a carbodiimide, optionally in the presence of an activating agent such as, for example, hydroxybenzotriazole or hydroxysuccinimide, with intermediate formation of dialkyl- or dicycloalkyl-O-ureides. Representative condensation agents are dicyclohexyl- and diisopropylcarbodiimides and carbodiimides soluble in an aqueous medium.

The compounds of formula IX are commercially available or easily prepared by an expert in the field starting from appropriate commercial compounds.

The activated derivatives of the acids of formula IX have as formula, for example, —CO-T where T is an activator group. Preferred activator groups are well known in the state of the art, such as, for example; halogen (chlorine or bromine), nitride, imidazolide, p-nitrophenoxy, 1-benzotriazole, O—N-succinimide, acyloxy and, more particularly, pivaloyloxy, alkoxycarbonyloxy such as, for example C₂H₅OCO—O—, dialkyl- or dicycloalky-O-ureide.

A series of methods suitable for the preparation of activated derivatives of carboxylic acid is proposed by J. March in Advanced Organic Chemistry, ed. John Wiley & Sons.

The optically pure compounds of formula VIII may be obtained by asymmetric epoxidation of the corresponding allyl alcohols of formula X:

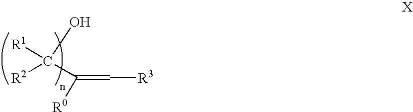

wherein n, R⁰ to R³ are as defined above for formula VIII, it being understood that X represents either the isomer E, or the isomer Z.

The conditions of this asymmetric epoxidation reaction are described in particular by Y-Gao, R. M. Hanson, J. M. Klunder and co., in J. Am. Chem. Soc. 1987, 109, 5765-5780. They involve the action, in the cold, of tert-butylhydroperoxide and the presence of Ti(O-iPr)₄ where iPr represents isopropyl and also the presence of diethyl (+)- or (−)-tartrate or of diisopropyl (+)- or (−)-tartrate. The reaction may be carried out in a polar aprotic solvent such as a halogenated aliphatic hydrocarbon (and for example dichloromethane) at a temperature of from −50 to 0° C., preferably from −30 to −10° C.

The quantity of epoxide functions incorporated in the polymer is easily determined by an expert in the field by dosage with periodic acid.

More precisely, the polymer of the invention is treated in an acid medium so as to bring about the opening of the epoxide functions into diol-1,2 functions. Then, the resultant polymer is reacted with an excess of periodic acid. This treatment leads to the transformation of the diol-1,2 functions into aldehyde functions according to the diagram:

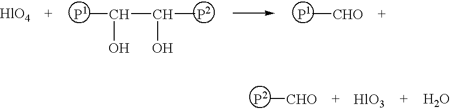

where (P¹) and (P²) represent fractions of said polymer.

HIO₃ and HIO₄ are then reduced by KI according to the reactions:

HIO₃+5KI+2H₂O→3I₂+5KOH

HIO₄+7KI+3H₂O→4I₂+7KOH.

The dosage of iodine liberated by the thiosulphate following the reaction:

2Na₂S₂O₃+I₂→Na₂S₄O₆+2NaI

allows determination of the excess of periodic acid used and indirectly of the quantity of epoxide functions initially present in the polymer.

The invention further concerns the optically active polymer that can be obtained by regiospecific stereoselective reaction of a nucleophilic agent on the polymer of the invention with epoxide functions as defined above, by which the partial or total regiospecific stereoselective opening of the epoxide functions of said reactive polymer is brought about.

The optically active polymer resulting from the attack of a nucleophilic agent is designated hereinafter as “modified polymer”.

Preferably, by the action of said nucleophilic agent the opening of the whole -of the epoxide functions is brought about.

Suitable nucleophilic agents are those comprising as nucleophilic site a halogen atom, an oxygen atom, a sulphur atom, a carbon atom, a nitrogen atom, a phosphorus atom or a selenium atom.

The nucleophilic agent and the operating conditions are more precisely selected so as to bring about the opening of the epoxide functions while conserving the chirality of at least one asymmetric centre. In this way, the resultant modified polymer is also optically active. More particularly suitable conditions for this purpose are in particular a basic or neutral medium.

The reaction of opening of the epoxides by the action of a nucleophile is described more precisely in the following works and publications:

J. March, Advanced Organic Chemistry “Reactions, mehcanism and structure”, 4th Ed. 1992, J. Wiley & Sons, p. 368;

R. J. Gritter, The chemistry of functional groups, “The chemistry of ether linkage”, S. Patai (Ed.) 1967, Interscience, p. 390-411 and cited references;

G. H. Posner, Angew. Chem. Int. Ed. Engl. 1978, 17, 487-496; and

F. A. Carey, R. J. Sundberg, “Advanced Organic Chemistry”, Part B, Reactions and Synthesis, 2nd ed., 1983, Plenum Press (Ed.) p. 498.

By way of example, the nucleophilic agent may be an amine (and particularly a diamine) or a hydroxyamine. As nucleophilic amine, a primary or secondary aliphatic amine, a (hetero)aromatic amine or a cyclic amine may be used. More generally, an amine of aliphatic, aromatic and/or cyclic nature may be used, that is to say, an amine having an aliphatic part or/and a (hetero)aromatic and/or cyclic part.

Preferably, the nucleophilic amine has as formula HNR^{d}R^{e} where R^{d} and R^{e} are independently selected from a saturated, linear or branched, optionally substituted, aliphatic hydrocarbonated chain; a saturated, optionally substituted carbocyclic group; an optionally substituted (hetero)aromatic group; a hydrogen atom; and a radical comprising a linear or branched hydrocarbonated saturated aliphatic chain, and a carbocyclic, saturated and/or (hetero)aromatic part, said radical being optionally substituted.

By saturated aliphatic hydrocarbonated chain, there is meant a linear or branched alkyl group as defined above or, when it is a radical including an aliphatic chain, the corresponding linear or branched saturated alkylene group.

By saturated carbocycle, there is meant a cycloalkyl radical as defined above. By carbocyclic part, there is meant the corresponding cycloalkylene radical.

By (hetero)aromatic, there is meant an aromatic carbocyclic radical or a heteroaryl radical.

The aromatic carbocyclic radicals are as defined above.

By heteroaryl, there is meant a mono- or polycyclic aromatic heterocycle comprising one or more heteroatoms selected from O, N and S. When the heteroaryl is polycyclic, it is then composed of monocyclic nuclei which are either aromatic heterocyclic or aromatic carbocyclic as defined above when at least one of said monocyclic nuclei forming it is aromatic heterocyclic. In the heteroaryl, the monocyclic nuclei constituting the heteroaryl are attached two by two by a single carbon-carbon bond and/or condensed with one another.

Preferably, the heteroaryl is composed of one or more monocyclic nuclei of 5 to 7 groups, advantageously 5 to 6 groups.

The heteroaryl is preferably selected from furyl, thienyl, pyrrolyl, oxazolyl, thiazolyl, imidazolyl, pyrrazolyl, isoxazolyl, isothiazolyl, pyridyl, pyridazinyl, pyrimidinyl, pyrazinyl, indolizinyl, indolyl, isoindolyl, benzofuryl, benzothienyl, benzimidazolyl, benzothiazolyl, quinolyl, isoquinolyl, cinnolinyl, phthalazinyl, quinazolinyl, quinoxalinyl, naphthyridinyl and pteridinyl.

The aliphatic chains and the carbocycles described above are optionally substituted. The substituents borne by these radicals are selected so as not to react with the epoxide functions of the polymer and more generally with the reagents present in the reaction conditions.

Suitable substituents are the substituents alkoxy; alkyl; aryl; heteroaryl; aryloxy; cycloalkyl; cycloalkyloxy; cyano; nitro; halogen; oxo; amino disubstituted by alkyl, aryl and/or cycloalkyl; —CONR^{a}R^{b} in which R^{a} and R^{b} are independently selected from H, alkyl, aryl and cycloalkyl; —COOR^{f} where R^{f} is as defined for R^{a}.

In addition, it will be noted that each of the radicals R^{d} and R^{e} of the nucleophilic amine may bear one or more other amino functions, optionally substituted, or/and hydroxy functions.

Other nucleophilic amines are the secondary heterocyclic amines in which the nucleophilic site —NH— is endocyclic. Said heterocyclic amine is either monocyclic, or polycyclic and optionally comprises, in addition to said —NH— function, one or more other heteroatoms such as O, N and S. The heterocyclic amine is saturated or unsaturated. In the latter case, it may comprise one or more ethylene unsaturations.

The heterocyclic amines consist of one or more monocyclic nuclei, said monocyclic nuclei each preferably having from 5 to 7 groups and being either connected to one another by single carbon-carbon bonds, or condensed two by two.

More particularly preferred examples of amines are the aliphatic amines, aliphatic diamines, arylalkylamines, aminopyridines, aminoalkylpyridines, aminoquinolines, aminoalkylquinolines, heterocyclic amines in which the nucleophilic site is —NH— such as the mono- and bicyclic heterocyclic amines comprising as the only heteroatoms 1 to 5 nitrogen atoms. A particular example of a heterocyclic amine is the following:

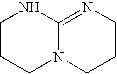

In the case of primary or secondary amines, a method consists in reacting the polymer with epoxide functions with 1 to 5 equivalents of the nucleophilic amine, preferably 2 to 4 equivalents, the equivalents being expressed in relation to the number of mols of epoxide functions present in the polymer.

The temperature of the reaction depends on the strength of the nucleophilic agent.

Generally, it is preferable to heat the reaction medium to a temperature of between 50 and 150° C., preferably between 80 and 120° C.

When the nucleophilic agent is an amine, the resultant modified polymer bears β-hydroxyamine functions:

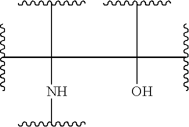

It will be designated hereinafter as polyaminoalcohol.

The nucleophilic agent generally attacks the epoxide functions of the polymer of the invention on the least encumbered side, that is to say, on the side furthest from the polymeric skeleton. The conditions of the nucleophilic attack are determined by an expert in the field for the, purpose of obtaining the opening of each of the epoxide functions with retention of the configuration at at least one of the asymmetric centres of said epoxide function.

The nucleophilic agent is selected according to the planned application.

Other suitable nucleophilic agents are described in Synthesis, 1984, 9, 629-656; J. Org. Chem. 40, 1975, 375-377; J. Am. Chem. Soc. 1953, 75, 1636; and Angew. Chem. Int. Ed. Engl. 1978, 17, 487-496.

Among these, there will be mentioned in particular:

nucleophilic agents with hydroxy function (such as water, alcohols and particularly C₁-C₁₀ alkanols, C₆-C₁₈ aromatic alcohols and arylalkylalcohols where the alkyl part is C₁-C₁₀ and the aryl part is C₆-C₁₈)

nucleophilic agents with thiol function (such as mercaptans and particularly thiols of formula M⁰-SH where M⁰ is for example a C₁-C₁₀ alkyl group; a C₆-C₁₈ aryl group; or a (C₆-C₁₈) aryl-(C₁-C₁₀)alkyl group);

nucleophilic agents with —SeH function (such as selenomercaptans and particularly selenols of formula M⁰-SeH where M⁰ is as defined above);

carboxylic acids with —COOH function and especially the acids of formula M⁰-COOH where M⁰ is as defined above;

sulphite and bisulphite anions;

sylilated halides of general formula XSiM¹M²M³ where X is a halogen atom, M¹, M² and M³ represent optionally substituted hydrocarbon radicals and are for example as defined for M⁰ above;

sylilated sulphides of general formula M-S—SiM¹M²M³ where M, M¹, M² and M³ represent optionally substituted hydrocarbon radicals and are especially those as defined for M⁰ above;

silylated selenides of general formula M⁴-Se—SiN¹M²M³ where M⁴, M¹, M² and M³ represent optionally substituted hydrocarbon radicals and are especially as defined for M⁰ above;

silylated cyanides of general formula NC—SiM¹M²N³ where M¹, M² and M³ represent optionally substituted hydrocarbon radicals and are for example as defined for M⁰ above;

tris(hydrocarbylselenyl)boranes of general formula B(Se-M′)₃ where M′ represents an optionally substituted hydrocarbon radical and is for example as defined above for M⁰;

tris(hydrocarbylthio)boranes of general formula B(S-M′)₃ where M′ represents an optionally substituted hydrocarbon radical and is for example as defined above for M⁰;

trihydrocarbylstannyllithium of general formula (M′)₃SnLi where M′ represents an optionally substituted hydrocarbon radical and is for example as defined above for M⁰;

carbanions coming from magnesians such as those of formula M′-MgX where M′ represents an optionally substituted hydrocarbon radical and is for example as defined above for M⁰;

carbanions coming from organomagnesians of formula (M′)₂Mg where M′ represents an optionally substituted hydrocarbon radical and is for example as defined above for M⁰;

carbanions coming from hydrocarbyllithians of general formula M′Li where M′ represents an optionally substituted hydrocarbon radical and is for example as defined above for M⁰, the nucleophilic attack being carried out in this case in the presence of copper salts;

carbanions coming from homocuprates of general formula M′M″CuLi where M′ and M″ represent independently an optionally substituted hydrocarbon radical and are for example as defined above for M⁰;

carbanions coming from mixed cuprates of general formula (M′CuCN)Li where M′ is as defined above;

carbanions coming from mixed cuprates of general formula M′M″CU(CN)Li₂ where M′ and M″ represent independently an optionally substituted hydrocarbon radical and are for example as defined above for M⁰;

nucleophilic agents of general formula M′-C≡CLi where M′ is as defined above for M⁰, the nucleophilic attack being carried but in this case in the presence of copper salts;

carbanions derived from malonates of general, formula M′OOC—CH⁻—COOM″ where M′ and M″ are as defined above.

Preferred nucleophilic agents are amines, quanidines, morpholines, and hydroxylamines.

The modified polymer of the invention is optically active. It is particularly useful as stationary phase in chiral chromatography, whether in preparatory chromatography or in analytical chromatography. For such use, the nature of the nucleophilic agent is not critical. However, it is preferred that the nucleophilic agent is an aliphatic or aromatic amine. Said polymer has modulable physical properties, thereby making it possible to improve the performances of the polymeric material and especially the effectiveness of separation. The modulation of the properties of the modified polymer is carried out during synthesis of the polymer with epoxide functions as taught previously.

The invention therefore concerns the use of a modified polymer resulting from the attack of a nucleophilic agent on the polymer with epoxide functions of the invention, as described above, as polymeric matrix usable in chiral chromatography.

It is also possible to graft the polymer of the invention onto a support used conventionally in chromatography such as, for example, silica or alumina, before its use in chromatography.

For grafting, an expert in the field will use the conventional techniques known in the art, recommended for the modification of silicas and aluminas. For the purpose of grafting, it is desirable to react the modified polymer of the invention on the appropriately functionalised silica or alumina.

Methods suitable for grafting are those as described in:

Reactive and Functional Polymers, 1997, 153;

Solid State Ionic, (1999), 29;

Tetrahedron: Asymmetry, (2000), 2183;

M. A. Brook, Silicon in Organic Organometallic and Polymer Chemistry : chapter 10, p. 309, J. Wiley, 1999;

Hydrid organic-inorganic composites, J. E. Mark, C. Y -C. Lee and P. A. Bianconi (Eds) 1995; ACS symposium series 585, chapters 8, 10, 11, 19 and 26.

The invention therefore concerns, according to another of its features, a polymeric material usable as stationary phase in chiral chromatography and able to be obtained by grafting reaction of the modified polymer of the invention onto a conventional support used in chromatography, chiral or non-chirai, such as silica or alumina.

Said modified polymer is also suitable for use

in solid phase synthesis, the modified polymer acting as chiral auxiliary;

in asymmetric catalysis, either as chiral inducer or as chiral ligand of a transition metal for the purpose of preparing catalysing-metallic complexes.

The modified polymers, of the invention are more particularly useful in the catalysis of the reactions of reduction of carbonyl functions, activated or not, or of reactions involving the formation of C—C bonds.

According to a first embodiment of the invention, the modified polymers of the invention are used as ligands for preparing, metallic complexes intended for asymmetric catalysis. In this case, the coordinating metal is a transition metal selected from rhodium, ruthenium, iridium, nickel, cobalt, palladium and platinum.

More precisely, when the opening of the epoxide functions of the polymers of the invention has been carried out by the action of an amine, type nucleophile as described above, the resultant modified polymer has β-hydroxy-amine functions and may be used directly as ligand for preparing metallic complexes. This polymer will be designated hereinafter as polyaminoalcohol. As a variant, the modified polymer may be again chemically transformed before the preparation of the metallic complex.

The modified polymers of the invention are further usable as they are or after further chemical transformation as asymmetric inducer in the reactions of reduction of carbonyl groups or/and in the reactions involving the formation of C—C bonds.

By way of example, inspiration may be drawn from the works described in Tetrahedron : Asymmetry, 1997, 8, 2881 and Tetrahedron : Asymmetry, 1997, 8, 1083 and the β-hydroxy-amine functions of the modified polymers described above may be transformed into amidophosphine-phosphinite functions of the formula:

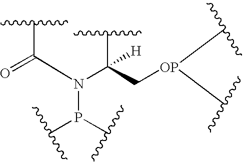

or aminophosphine-phosphinite functions of the formula:

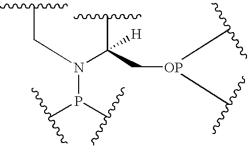

Thus transformed, the modified polymers of the invention are usable as ligands of ruthenium (II) for preparing complexes usable in asymmetric hydrogenation of α-ketoesters or β-ketoesters.

Another possibility consists in transforming the β-hydroxy-amine functions of the modified polymers into oxazaborolidine or phosphoramidate functions of the formula:

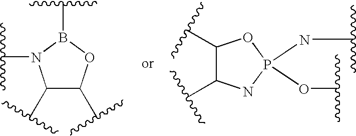

Conforming to the works of:

J. Chem. Soc. Chem. Commun, 1981, 315;

Angew. Chem. Int. Ed. Engl. 1996, 35, 1992;

Asymmetry, 1994, 5, 1211;

Tetrahedron: Asymmetry, 1994, 5, 165;

Tetrahedron Lett. 1993, 34, 3243;

Tetrahedron: Asymmetry, 1997, 8, 1259;

J. Am. Chem. Soc. 1996, 118, 10938;

Tetrahedron: Asymmetry, 1997, 8, 277;

Tetrahedron Lett. 1998, 39, 1705.

The modified polymers with oxazaborolidine or phosphoramidate functions may be used as they are as catalysts in the asymmetric reduction of varied ketones such as aliphatic and/or aromatic ketones, the aliphatic ketones being saturated or unsaturated (the unsaturations being ethylene or acetylene unsaturations). One will proceed thus for example for the reduction of aliphatic ketone or of benzophenones to corresponding secondary alcohols.

Moreover, the reduction of α-ketoester or β-ketoesters into corresponding α- or β-hydroxyesters may be carried out in accordance with the works of Chem. Rev. 1992, 92, 935 in the presence of a modified Pt/Al₂O₃ catalyst. Within the framework of the invention, there will be used for this reaction a Pt/Al₂O₃ catalyst comprising as ligand a modified polymer of the invention, with β-hydroxylamine functions (polyaminoalcohol).

The modified polymers of the invention with β-hydroxylamine functions (polyaminoalcohols) are also usable as ligands of complexes of ruthenium II for catalysing the asymmetric reduction of aromatic, cyclic and/or aliphatic ketones by hydride transfer. This type of reaction is illustrated in particular in:

J. Chem. Soc. Chem. Commun, 1996, 233;

J. Org. Chem. 1997, 62, 5226; and

J. Org. Chem. 1998, 63, 2749.

Another type of reactions catalysable by complexes of nickel and cobalt prepared by using as ligands the modified polymers of the invention with β-hydroxylamine functions (polyaminoalcohols) are the Michael type reactions of addition such as those illustrated in:

Tetrahedron: Asymmetry, 1.997, 8, 1467; and

Tetrahedron: Asymmetry, 1997, 8, 1377,

which more precisely concern the addition of dialkyl-zinc or diaryl-zinc onto α,β-ethylene ketones.

The modified polymers of the invention with β-hydroxylamine functions (polyaminoalcohols) are moreover usable as asymmetric inducer in the addition of dialkyl-zinc or diaryl-zinc onto aldehydes. For this type of reaction, reference may be made to the works of:

Chem. Rev. 1992, 833;

Angew. Chem. Int. Ed. Engl. 1991, 30, 49; and

Chem. Rev. 2000, 100, 2159-2231.

Similarly, the modified polymers of the invention with β-hydroxylamine functions (polyaminoalcohols) are usable as asymmetric inducer in the reactions of addition of dialkyl-zinc or diaryl-zinc onto ketones (cf. J. Am. Chem. Soc. 1998, 120, 12157). For the execution of this method, an expert in the field may draw inspiration from the works of Pericas et al., described in J. Org. Chem. 1998, 63, 6309, and also to the following publications:

Tetrahedron: Asymmetry, 1997, 8, 1529; and

Angew. Chem. Int. Ed. Engl. 1996, 35, 642.

The modified polymers with β-hydroxylamine functions (polyaminoalcohols) used for the purpose of one of the applications in asymmetric catalysis which are described above result more specifically from the attack of the epoxide functions of a polymer according to the invention by a nucleophilic agent selected from an arylalkylamine (especially benzylamine); an (arylalkyl)(alkyl)amine, especially (benzyl) (methyl)amine; and a heterocyclic amine of the formula:

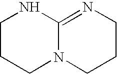

The complexes comprising a modified polymer of the invention and a transition metal may be prepared according to the known methods described in the literature.

For the preparation of complexes of ruthenium, reference may be made in particular to the publication of J.-P. Genêt [Acros Organics Acta, 1, No. 1, pp. 1-8 (1994)] and for the other complexes to the article by Schrock R. and Osborn J. A. [Journal of the American Chemical Society, 93, pp. 2397 (1971)].

Generally, the complexes of the invention may be prepared by reaction of the modified polymer of the invention with a precursor based on the desired transition metal, in a suitable organic solvent.

The reaction is conducted at a temperature ranging between ambient temperature (from 15 to 25° C.) and the reflux temperature of the reaction solvent.

As examples of organic solvents, among others there may be mentioned aliphatic hydrocarbons, halogenated or not, and more particularly hexane, heptane, isooctane, decane, benzene, toluene, methylene chloride, chloroform; solvents of the ether or ketone type and especially diethylether, tetrahydrofuran, acetone, methylethylketone; solvents of the alcohol type, preferably methanol, ethanol or isopropanol; and solvents of the amide type such as formamide, dimethylformamide, dimethylacetamide, N-methyl-2-pyrrolidinone, hexamethylphosphorylamide, dimethylformamide being the preferred amide.

The catalytic complexes based on rhodium, iridium and ruthenium are for example obtained starting from a precursor prepared in situ or preformed by addition of 1 to 10, preferably 1 to 2 equivalents of the modified polymer of the invention (designated hereinafter as polymer P).

In the case of rhodium, iridium and ruthenium, the precursors may be salts of the formula MX₃ in which X may represent a halide or a nitrate and M represents respectivly Rh, Ir or Ru. As a variant, the precursor used for the synthesis of the catalytic complexes is a complex designated hereinafter as precursor complex.

In the case of iridium and rhodium, the precursor complexes, known by an expert in the field, may be defined by the following formula:

[MeX⁰L₂]₂

wherein Me represents iridium or rhodium; L represents a type II ligand, in particular CO, ethylene or a mono-olefin, or L₂ represents a bidentate type II ligand such as an acyclic diene, for example hexadiene, or cyclic diene, for example cyclooctadiene or norbornadiene; X⁰ represents a bridging ligand such as, for example, a halogeno (Cl, Br, I), a thiolato, an alcoholato, a hydroxy.

As examples of precursor complexes in the case of rhodium, there may be mentioned the Cramer complex, [Rh(cod)Cl]₂, [Rh(nbd)Cl]₂, [Rh(CO)₂Cl]₂, Rh(C₂H₄)₂ (acac), Rh(CO)₂(acac), [Ir(cod)Cl]₂, [Ir(nbd)Cl]₂, Ir(C₂H₄)₂(acac) and Ir(CO)₂(acac),

where cod represents cyclooctadiene;

nbd represents norbornadiene; and

acac represents acetylacetonate.

Other precursor complexes in the case of rhodium and iridium have the formula:

[MeL₄]X¹

wherein Me represents iridium or rhodium; L represents a type II ligand, in particular ethylene, a mono-olefin or CO; or L₂ represents a bidentate type II ligand such as a diolefin; X¹ represents a non-coordinant anion of the type PF₆⁻, PCl₆⁻, BF₄⁻, BCl₄⁻, SbF₆⁻, SbCl₆⁻, BPh₄⁻, ClO₄⁻, CF₃SO₃⁻.

As examples of such precursors, there may be mentioned Rh(cod)₂BF₄ and Ir(cod)₂BF₄ where cod represents cyclooctadiene.

In the case of ruthenium, the precursor complexes known to an expert in the field may be defined by the following formula:

[RuL₂X²₂]₂

wherein L represents a type II ligand, in particular CO, ethylene or a mono-olefin; or L₂ represents a bidentate type II ligand and for example an acyclic diene such as hexadiene or a cyclic diene such as cyclooctadiene or norbornadiene; X² represents a bridging ligand such as for example a halogeno (Cl, Br, I), a thiolato, an alcoholato, a hydroxy.

As examples of such precursor complexes, there may be mentioned [Ru(cod)Cl₂]₂ where cod represents cyclooctadiene.

As other precursor complexes, there may be mentioned the complexes of formula [RuL₂X²]₂ where L and X² are such as defined above for [RuL₂X²]₂. For example, [Ru(CO)₂CH₃COO]₂ may be mentioned.

Other precursor complexes in the case of ruthenium have the formula : RuX³₂L₄, where L represents a type II ligand, in particular CO, ethylene or a mono-olefin, or L₂ represents a bidentate type II ligand and for example an acyclic diene such as hexadiene or a cyclic diene such as cyclooctadiene and norbornadiene; or L₃ represents a tridentate type II ligand such as an arene, functionalised or not; X³ represents a bridging ligand such as for example a halogeno (Cl, Br, I), a thiolato, an alcoholato, a hydroxy.

Examples of precursor complexes of this type are Ru(C₁₁H₁₉O₂)₂(C₈H₁₂) and [Ru(benzene) Cl₂]₂.

This list is non-limiting and an expert in the field may draw inspiration for example from the metallic precursors described in Comprehensive Organometallic Chemistry, G. Wilkinson, F. G. A. Stone and E. W. Abel (Eds), Pergamon Press, 1982 and Comprehensive Organometallic Chemistry II, R. J. Puddephatt, E. W. Abel, F. G. A. Stone and G. Wilkinson (Eds), Pergamon Press/Elsevier, 1995, and from those described in Comprehensive Coordination Chemistry, G. Wilkinson, R. D. Gillard and J. A. McCleverty (Eds), Pergamon/Elsevier, 1987. Similarly, he may find there the know-how permitting him to form new complexes derived from polymers of the invention which are described above.

The complexes of ruthenium II with a modified polymer according to the invention with β-hydroxylamine functions (polyaminoalcohols) are more particularly suitable for the asymmetric catalysis of reactions of reduction of carbonylated functions by hydride transfer.

Thus, according to another of its features, the invention concerns the metallic complex of a transition metal comprising, as ligand, a polymer of the invention or a modified polymer obtained by the action of a nucleophilic agent on a polymer of the invention, by which the opening of the epoxide functions is brought about.

Advantageously, the transition metal in this complex is ruthenium, iridium or rhodium, preferably ruthenium.

Examples of ketones that may be selected as substrate for the reactions of reduction by hydride transfer more preferably correspond to the formula C:

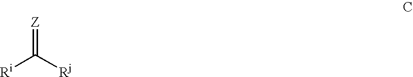

wherein:

Rⁱ is different from R^{j},

Rⁱ and R^{j} represent a hydrocarbon radical having from 1 to 30 carbon atoms, optionally comprising one or more functional groups,

Rⁱ and R^{j} may form a cycle, optionally comprising another heteroatom.

Z is or comprises a heteroatom, oxygen or nitrogen or a functional group comprising at least one of these heteroatoms.

A first preferred group of such ketone substrates has the formula D :

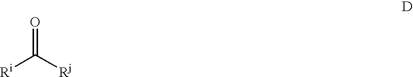

wherein:

Rⁱ is different from R^{j}, the radicals Rⁱ and R^{j} representing a hydrocarbon radical having from 1 to 30 carbon atoms, optionally substituted, and optionally comprising another ketone and/or acid, ester, thioacid, thioester function;

Rⁱ and R^{j} may form a carbocyclic or heterocyclic cycle, substituted or not, having from 5 to 6 atoms.

Examples of particularly suitable substrate ketones are acetophenone, (phenyl)(trifluoromethyl)ketone, α-ketoesters and β-ketoesters.

The reduction of ketones by hydride transfer is carried out conventionally, using as catalyst the metallic complexes of the invention which are described above.

Reduction is carried out in a basic medium, for example in the presence of an organic base such as an alkaline metal alcoholate and more particularly ^{t}BuOK or of an inorganic base such as NaOH, KOH, NaHCO₃, Na₂CO₃, KHCO₃ and K₂CO₃.

Reduction is carried out in the presence of a hydrophilic polar organic solvent such as a C₁-C₁₀ lowers aliphatic alcohol (for example methanol, ethanol, propanol, isopropanol, butanol, t-butanol), a cycloalkanol (such as cyclohexanol), or methylcellosolve.

The reaction temperature is generally maintained between ambient temperature (15-30° C.) and the reflux temperature of the solvent, in general up to 150° C.

The reduction conditions will be easily refined by an expert in the field, for example with reference, to Tetrahedron Lett. 1995, 36, 8776, Bull. Soc. Chim. Fr. 1994, 13, 600 and Chem. Rev., 1985, 85, 129.

The invention therefore more generally concerns the use of a modified polymer as ligand, optionally after transformation into oxazaborolidine or phosphoramidate, in the preparation of transition metal complexes or as chiral inducer, in stereoselective catalysis.

Said complexes are more particularly suitable for catalysing the stereoselective reduction of carbonyl and imine functions or for catalysing reactions involving the formation of a C—C bond.

The polymers with epoxide function of the invention are further usable as polymeric material for immobilising enzymes.

The immobilisation of enzymes on solid supports provides practical advantages for the execution of biocatalytic methods. Among these advantages, the ease of separation of the reaction medium is a major trump card permitting the recycling of the material.

The reactivity of the polymers of the invention with epoxide function permits easy grafting of the enzyme to the polymeric skeleton by means of the hydroxyl, thiol and/or amino functions of the enzyme.

As a variant, it is possible to immobilise the enzymes on the modified polymer of the invention resulting, for example from the nucleophilic attack of a diamine on the polymer with epoxide functions of the invention.

In order so to do, it is sufficient, for example, to react said modified polymer on glutaraldehyde before reacting it with the enzyme to be immobilised.

In order so to do, an expert in the field will refer for example to Adv. Mater. 1999, 11, 1169-1181.

The invention therefore also deals with the use of a polymer with epoxide functions or of a modified polymer according to the invention as polymeric material for immobilising enzymes.

According to another of its features, the invention concerns the use of a modified polymer of the invention as defined above as polymeric support in solid phase synthesis.

The invention is illustrated more precisely below by means of the following examples.

In examples 4.1,to 4.6, 10.1 to 10.3, 11 and 15, the functionalisation rate, (f) is the maximum number of mols of nucleophile introduced per gram of polymer. It is defined more precisely by the formula f=f0/(1+f0×PM/1000)), where f0 represents the number of epoxide functions per gram of initial monomer with epoxide function and PM the weight of the nucleophile.

### EXAMPLE 1

### Preparation of Optically Pure Glycidyl Methacrylate by Enzymatic Resolution

To 10 g of glycidyl methacrylate (70.3 mmols) dissolved in 80 ml of twice-distilled water there are added, while stirring, 10 g of lipase (E.C. 3.1.1.3, sigma type II coming from pig pancreas). The pH is maintained at 7.8 by an addition of sodium (1.4 mol/l) by means of an automatic burette (measurement of pH by means of a pH meter and a double glass—calomer—electrode), thereby making it possible to follow the state of advance of the reaction. After 24 hours (conversion: 57%), the reaction mixture is filtered on a No. 3 sintered glass covered with 300 g of silica. The silica is washed with 300 ml of technical dichloromethane. The organic phase is concentrated (30 ml) and washed with an aqueous solution saturated with sodium bicarbonate (25 ml), then with permuted water (2×15 ml). After drying on a sodium sulphate/sodium bicarbonate mixture (90/10) then evaporation, 3.11 g of glycidyl methacrylate (21.9 mmols) are obtained.

Yield: 31.2% Enantiomeric excess of glycidyl (R)-methacrylate: 70% ([α]_{D}²⁵=−20.6; c=0.564, CH₂Cl₂).

### EXAMPLE 2

### Preparation of Optically Pure Glycidyl Methacrylate by Chemical Resolution

To 0.457 g (0.668 mmols) of (1R, 2R)-(−) -1, 2-diaminocyclohexane-N,N′-bis(3.5-di-tert-butylsalicylidene)cobalt (II) dissolved in 12 ml of technical toluene there are added 76 μl (1,336 mmols) of 99.8% acetic acid, while stirring. After one hour at ambient temperature, the solvent is evaporated. At 0° C., to the black residue obtained there are added19 g (133 mmols) of racemic glycidyl methacrylate, then, drop by drop, 1.20 g (66 mmols 0.55 eq.) of permuted water. The reaction mixture is allowed to return to ambient temperature. After 24 hours, the glycidyl (R)-methacrylate transformed into diol is separated from the glycidyl (S)-methacrylate by chromatography on silica gel (Merck 60; 40-63 μm) (600 g of silica to 20 g of product deposited; eluant: dichloromethane).

Yield: 35% Enantiomeric excess: 99.8% (determined by CGL on a chiral column, type Supelco β dex 225, 30 m×25 mm); [α]_{D}²⁵ +29.3; c=0.564, CH₂Cl₂ IR (film) (cm⁻¹): 3040, 2961, 1725, 1642, 1270, 1168, 913. NMR¹H (200 MHz, CDCl₃) δ (ppm) : 1.95 (s, 3H); 2.6-2.7 (m, 1H); 2.8-2.9 (m, 1H) 3.9-4.0 (m, 1H); 4.4-4.5 (m, 1H) 5.52 (s, 1H); 6.18 (s, 1H). NMR¹³C (50 MHz, CDCL₃)δ(ppm) 18.3; 44.6; 65.2; 126.2; 135.9; 167.0.

### EXAMPLE 3

### Preparation of the Optically Active Polymer with Epoxide Functions

1.5 g of polyvinylpyrrolidone are dissolved at 80° C. in 100 ml of permuted water, then the volume of the mixture is made up to 150 ml with permuted water. In parallel, 204 mg of azo-bis-isobutyronitrile (AIBN) are dissolved in a mixture formed of 6.13 g of optically pure glycidyl methacrylate and 14.30 g of ethyleneglycol dimethacrylate (30% by mass of glycidyl methacrylate—70% by mass of ethyleneglycol dimethacrylate) to which is added a mixture composed of 24.64 g of cyclohexanol and 2.43 g of dodecanol. The aqueous phase containing polyvinylpyrrolidone is placed, under nitrogen, in a double-wall reactor equipped with a mechanical stirrer and with a cryostat. To this aqueous phase there are added, drop by drop, the glycidyl methacrylate/ethyleneglycol dimethacrylate/AIBN and cyclohexanol/dodecanol mixtures. The reaction mixture, stirred at 200 r.p.m. is heated at 70° C. for 2 hours then at 80° C. for 6 hours and finally left at ambient temperature for 2 hours. The polymer balls are recovered with ethanol at 95%. The polymer balls are then divided into three fractions and subjected to agitation by means of a shaker for 2 hours and the solvent is eliminated by decanting. Each fraction is then washed with 30 ml of ethanol at 95%, agitated by means of a shaker (2 hours) and the solvent is then eliminated by decanting. This operation is repeated 4 to 5 times. The polymer balls are then dried in a vacuum oven at 40° C. for 4 hours. They are then separated by passing through three screens: 500 μm, 300 μm and 106 μm. Four fractions are thus obtained.

Elemental analysis:

| | | | |
|---|---|---|---|
| Calculated: | C: 60.17%; | H: 7.06%; | O: 32.77% |
| Experimental: | C: 59.75%; | H: 7.40%; | O: 32.85%. |
| f0: | 2.11 meq./g. | | |

### EXAMPLE 4

### Synthesis of a Modified Polymer According to the Invention of the Polyaminoalcohol Type

Under an argon atmosphere, the chiral polymer obtained in example 3 (1 mmol of epoxide) is placed in suspension in 2 ml of anhydrous dimethylformamide, then 3 equivalents of an amine (nucleophilic agent) are added while mechanically stirring (anchor) the reaction mixture (180 r.p.m.). The following table summarises all the reactions carried out.

| | | | | | Functional- |
|---|---|---|---|---|---|
| | | Diameter | Elemental analyssis | | isation rate |
| | | of | of modified polymer | | in polymer |
| | | polymer | obtained | | obtained |
| | | balls | Calculated | Found | (%: mmol/g |
| Example | Amine | (μm) | (%) | (%) | of polymer) |

| | | | | | |
|---|---|---|---|---|---|
| 4.1 | 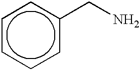 | 300-500 | C: 62.64 H: 7.24 O: 28.45 N: 1.67 | C: 61.05 H: 7.15 O: 30.1 N: 1.15 | 69: 1.20 |
| 4.2 | 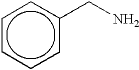 | 106-300 | C: 63.54 H: 7.31 N: 2.41 | C: 59.52 H: 7.21 N: 1.49 | 62: 1.14 |
| 4.3 | 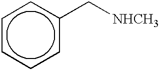 | 300-500 | C: 63.12 H: 7.37 O: 27.80 N: 1.71 | C: 63.69 H: 7.67 O: 28.23 N: 0.95 | 71: 1.22 |
| 4.4 | 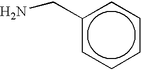 | 300-500 | C: 63.03 H: 7.43 O: 28.19 N: 1.35 | C: 62.40 H: 7.75 O: 28.50 N: 1.26 | 59: 0.94 |
| 4.5 | CH₃NH₂ | 106-300 | C: 58.55 H: 7.62 N: 2.78 | C: 58.45 H: 7.25 N: 1.01 | 36: 0.76 |
| 4.6 | 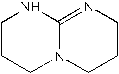 | 106-300 | C: 60.24 H: 7.56 N: 6.80 | C: 56.25 H: 7.38 N: 3.52 | 53: 1.10 |

In an analogous manner, the modified polymers of examples 4.7 and 4.8 are prepared by reaction of the following amines on the chiral polymer obtained in example 3.

| Example | Nucleophilic amine |
|---|---|
| 4.7 | 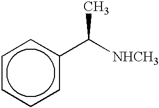 |
| 4.8 | 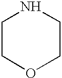 |
| 4.9 | 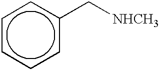 |

### EXAMPLE 5

### Preparation of Catalyst Complexes Starting from Modified Polymers Prepared in Example 4

The catalyst is prepared in situ. Under an argon atmosphere, one of the polyaminoalcohol type ligands prepared in example 4 and RuCl₂(p-cymene)₂ are placed in suspension in isopropanol, in a molar ratio of ligand/metal of 4/1, (2 ml per 3.7 mg of RuCl₂(p-cymene)₂). This suspension is agitated for 30 minutes at 80° C. A change of colour from yellow to red of the reaction mixture and of the balls is observed.

The following table summarises all the reactions carried out.

| Example | Starting polyaminoalcohol |
|---|---|
| 5.1 | 4.1 |
| 5.2 | 4.3 |
| 5.3 | 4.4 |
| 5.4 | 4.5 |
| 5.5 | 4.7 |
| 5.6 | 4.8 |
| 5.7 | 4.9 |

### EXAMPLE 6

### Use of the Catalyst Complexes Prepared in Example 5 in the Reduction of Acetophenone

After cooling to ambient temperature, one of the catalysts prepared in example 5, and apetophenone are added so as to obtain a substrate/metal ratio of 20/1. Then a solution of 0.03 mol/l of potassium tertiobutylate in isopropanol (Ru/base ratio of 1/5) is added. The reaction mixture is agitated for 3 hours. The determination of the enantiomeric excesses is carried out by LGC on a chiral column type Supelco (β-dex 225 30 m×25 mm). The- results obtained with the different ligands are collated in the following table:

| | | Reaction | Conversion | |
|---|---|---|---|---|
| Example | Complex | time (hrs) | (%) | e.e. (%) |
| 6.1 | 5.1 | 2 h 45 | 94 | 70(R) |
| 6.2 | 5.2 | 22 | 7 | 29 |
| 6.3 | 5.3 | 22 | 11 | 34 |
| 6.4 | 5.5 | 22 | 7 | 23 |
| 6.5 | 5.7 | 22 | 94 | 45 |
| 6.6 | 5.6 | 22 | 10 | 10 |
| 6.7 | 5.4 | 1 h 15 | 95 | 65(R) |

### EXAMPLE 7

### Preparation of Optically Pure 3-phenyl-oxiranylmethyl 2-methyl-acrylate

2 g (13 mmol) of (2R,3R)-(3-methyl-oxiranyl)-methanol are dissolved in 20 ml of toluene. The reaction medium is agitated magnetically at 0° C. under argon. 3.75 ml (26.6 mmol) of triethylamine are added, then 1.6 ml (16 mmol) of methacryloyl chloride. The reaction mixture is heated to 110° C. After 24 hours, the mixture diluted with 30 ml of toluene is washed 3 times with 20 ml of permuted water, then 3 times with 20 ml of a saturated aqueous solution of NaHCO₃. The organic phase is dried with MgSO₄ and the solvent is evaporated. 2.83 g of 3-phenyl-oxiranylmethyl (2R,3R)-2-methyl-acrylate are obtained.

Yield 97% [α]_{D}²⁵=+49.6(c=1, CH₂Cl₂); Enantiomeric excess=99.5% NMR¹H (200 MHz, CDCl₃) δ (ppm): 2.00 (s, 1H); 3.30-3.35 (m, 1H); 3.85 (d, 1H ; J=2 Hz), 4.15-4.25 (dd, 1H; J=5.80 Hz), 4.55-4.60 (dd, 1H .J=3.3 Hz, J=12.3 Hz), 5.65 (s, 1H), 6.20 (s, 1H), 7.30-7.40 (m, 5H) NMR¹³C (50 MHz, CDCl₃) (ppm) 18.4; 56.5; 59.4; 64.5; 125.8; 126.4; 128.5; 128.6; 135.9; 136.3; 167.0.

### EXAMPLE 8

### Preparation of an Optically Active Copolymer with Epoxide Functions

0.63 g of polyvinylpyrrolidone are dissolved at 80° C. in 150 ml of permuted water. In parallel, 4 g of 3-phenyl-oxiranylmethyl 2-methyl-acrylate are mixed with 6 g of ethylene glycol dimethacrylate. 1.56 g of dodecanol, 15.27 g of cyclohexanol are added to this mixture, and 82 mg of AIBN. In a double-wall reactor equipped with a mechanical stirrer and a cryostat, the aqueous phase containing the polyvinylpyrrolidone is introduced under nitrogen. Then the 3-phenyl-oxiranylmethyl 2methyl-acrylate/ethylene glycol dimethylacrylate/AIBN/dodecanol/cyclohexanol mixture is introduced, drop by drop, into the reactor. The reaction mixture is agitated at 600 r.p.m., heated at 70° C. for 2 hours, then at 80° C. for 6 hours, and is cooled to ambient temperature for 2 hours. The copolymer balls are recovered with ethanol at 96%, and divided into three fractions which are agitated by means of a shaker for 2 hours. The supernatant of each fraction is replaced with 30 ml of ethanol at 96%. This operation is repeated 4 to 5 times. The balls are separated by means of three screens, 80 μm, 50 μm, and 25 μm. Four fractions are thus obtained.

Elemental analysis:

| | | | |
|---|---|---|---|
| Calculated | C: 65.02%, | H: 7.80%, | O: 28.18% |
| Experimental | C: 62.94%, | H: 6.96%, | O: 28.88%. |
| f0 = | 1.83 meq/g | | |

### EXAMPLE 9

### Preparation of an Optically Active Copolymer with Epoxide Functions

3 g of polyvinylalcohol are dissolved at 80° C. in 150 ml of permuted water. In parallel, 2.6 g of glycidyl methacrylate are mixed with 6 g of 1,4-divinylbenzene (purity : 80%). 1.06 ml of dodecanol, 12.48 ml of cyclohexanol are added to this mixture, and also 188 mg of AIBN. In a double-wall reactor equipped with a mechanical stirrer and a cryostat, the aqueous phase containing the polyvinylalcohol is introduced under nitrogen. Then the glycidyl methacrylate/divinylbenzene/AIBN/dodecanol/cyclohexanol mixture is introduced, drop by drop, into the reactor. The reaction medium is agitated at 400 r.p.m., heated at 70° C. for 2 hours, then at 80° C. for 6 hours, then cooled to ambient temperature for 2 hours. The copolymer balls are recovered with ethanol at 96%, and washed with acetone by means of a Soxhlet apparatus for 8 hours. The polymer is dried.

Elemental analysis:

| | | | |
|---|---|---|---|
| Calculated | C: 81.87%, | H: 7.75%, | O: 10.37% |
| Experimental | C: 82.39%, | H: 7.98%, | O: 9.62%. |
| f0 = | 2.11 meq/g | | |

### EXAMPLE 10

### Preparation of Modified Polymers According to the Invention of the Polyaminoalcohol Type

Under an argon atmosphere, the chiral polymer obtained in example 8 (1 mmol of epoxide) is placed in suspension in a minimum of anhydrous dimethylformamide. 10 equivalents of a nucleophilic amine are added while mechanically stirring the reaction medium (100 r.p.m.). After 24 hours at 100° C, the reaction medium is decanted into a flask. The supernatant is replaced with 50 ml of ethanol at 96%. The flask is placed on a shaker for 1 hour, then the supernatant is replaced with 50 ml of permuted water. These alternate washings with ethanol and water are repeated several times before the polymer is dried by means of a vacuum oven for 4 hours. The following table summarises all the reactions carried out starting from three different amines.

| | | |
|---|---|---|
| | | Functional- |
| Diameter | Elemental analysis | isation rate |
| of | of modified polymer | in polymer |
| polymer | obtained | obtained |

| | | | | | |
|---|---|---|---|---|---|
| | | balls | Calculated | Found | (%: mmol/g |
| Example | Amine | (μm) | (%) | (%) | of polymer) |

| | | | | | |
|---|---|---|---|---|---|
| 10.1 | 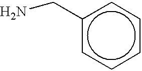 | 80-300 | C: 66.66 H: 7.83 N: 2.11 | C: 63.14 H: 7.07 N: 0.96 | 45: 0.68 |
| 10.2 | H₂NCH₃ | 80-300 | C: 63.04 H: 8.16 N: 2.36 | C: 62.60 H: 7.06 N: 0.70 | 29: 0.51 |
| 10.3 | 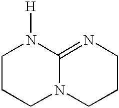 | 80-300 | C: 63.58 H: 8.06 N: 6.08 | C: 60.43 H: 7.38 N: 2.05 | 34: 0.49 |

### EXAMPLE 11

### Synthesis of a Modified Polymer According to the Invention of the Polyaminoalcohol Type

Under an argon atmosphere, the chiral polymer obtained in example 9 (1 mmol of epoxide) is placed in suspension in benzylamine while mechanically stirring the reaction medium (100 r.p.m.). After 24 hours at 80° C., the reaction medium is centrifuged at 4000 r.p.m. The supernatant is removed to be replaced with ethanol at 96%. Then the polymer is dried by means of a vacuum oven for 4 hours.

| | | Diameter | | | | |
|---|---|---|---|---|---|---|
| | | of | | | | |
| | | polymer | Elemental analysis | | Functional- | |
| | | balls | Calculated | Found | isation rate | |
| Example | Amine | (μm) | (%) | (%) | % | mmol/g |
| 11 | 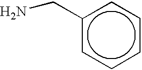 | 80-300 | C: 81.21 H: 7.89 N: 2.55 | C: 83.42 H: 7.44 N: 1.57 | 61 | 1.04 |

### EXAMPLE 12

### Preparation of Catalyst Complexes Starting from Modified Polymers prepared in Examples 10 and 11

The catalyst is prepared in situ. Under an argon atmosphere, one of the polyaminoalcohol type ligands prepared in example 10 or 11 and [RuCl₂(p-cymene)]₂ are placed in suspension in isopropanol, in a molar ratio of ligand/metal of 4/1, (2 ml per 3.7 mg of [RuCl₂(p-cymene)]₂. This suspension is agitated for 1 hour at 80° C. A change of colour from yellow to red of the reaction medium is observed.

The following table summarises all the reactions carried out.

| Example | Starting polyaminoalcohol |
|---|---|
| 12.1 | 10.1 |
| 12.2 | 10.2 |
| 12.3 | 11 |

### EXAMPLE 13

### Use of the Catalyst Complexes Prepared in Example 12 in the Reduction of Acetophenone

At ambient temperature, one of the catalysts prepared in example 12 and acetophenone are added (molar ratio of substrate/metal: 20/1). Then a solution of 0.03 mol/l of potassium tertiobutylate in isopropanol (ratio of Ru/base: 1/5) is added. The reaction mixture is agitated magnetically. Sampling is carried over the course of time and the samples are analysed. The enantiomeric excesses are determined by GPC on a chiral column, type Supelco (Lipodex A 30×25). The results with the different ligands are summarised in the following table:

| Example | Complex | Time (hrs) | Conversion (%) | e.e. (%) |
|---|---|---|---|---|
| 13.1 | 12.1 | 22 | 61 | 21 |
| 13.2 | 12.2 | 3 days | <5 | 29 |
| 13.3 | 12.3 | 22 | 58 | 44 |

### EXAMPLE 14

### Preparation of an Optically Active Copolymer with Epoxide Functions

0.73 g of polyvinylpyrrolidone are dissolved at 80° C. in 150 ml of permuted water.

In parallel, 7 g of glycidylmethacrylate are mixed with 3 g of ethylene glycol dimethacrylate, 1.18 g of dodecanol, 12.06 g of cyclohexanol are added to this mixture, and 105 mg of AIBN. In a double-wall reactor equipped with a mechanical stirrer and a cryostat, the aqueous phase containing the polyvinylpyrrolidone is introduced under nitrogen. Then the glycidyl methacrylate/ethylene glycol dimethacrylate/AIBN/dodecanol/cyclohexanol mixture is introduced, drop by drop, into the reactor. The reaction medium is agitated at 400 r.p.m., heated at 70° C. for 2 hours then at 80° C. for 6 hours, and it is cooled to ambient temperature for 2 hours. The copolymer balls are recovered with ethanol at 96%, and divided into three fractions which are agitated by means of a shaker for 2 hours. The supernatant of each fraction is replaced by 30 ml of ethanol at 96%. This operation is repeated 4 to 5 times. The balls are separated by means of three screens, 80 μm, 50μm, and 25 μm. Four fractions are thus obtained.

Elemental analysis:

| | | | |
|---|---|---|---|
| Calculated | C: 59.50%, | H: 7.19%, | O: 33.25% |
| Experimental | C: 59.86%, | H: 7.28%, | O: 32.85%. |
| f0 = | 4.90 meq/g | | |

### EXAMPLE 15

### Synthesis of a Modified Polymer According to the Invention of the Polyaminoalcohol Type

Under an argon atmosphere, the chiral polymer obtained in example 14 (1 mmol of epoxide) is placed in suspension in benzylamine while mechanically stirring the reaction medium (100 r.p.m.). After 24 hours at 80° C., the reaction medium is decanted into a flask. The supernatant is replaced with 50 ml of ethanol at 96%. The flask is placed on a shaker for 1 hour, then the supernatant is replaced with 50 ml of permuted water. These alternate washings with ethanol and water are repeated several times before the polymer is dried by means of a vacuum oven at 50° C. for 4 hours.

| | | Diameter | | | | |
|---|---|---|---|---|---|---|
| | | of | | | | |
| | | polymer | Elemental analysis | | Functional- | |
| | | balls | Calculated | Found | isation rate | |
| Example | Amine | (μm) | (%) | (%) | % | mmol/g |
| 6 | 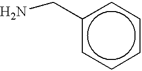 | 80-300 | C: 66.28 H: 7.66 N: 4.49 | C: 63.25 H: 7.57 N: 3.09 | 67 | 2.16 |

### EXAMPLE 16

### Preparation of Catalyst Complexes Starting from Modified Polymers Prepared in Example 15

The catalyst is prepared in situ. Under an argon atmosphere, the polyaminoalcohol type ligand prepared in example 15 and [RuCl₂(p-cymene)]₂ are placed in suspension in isopropanol, in a molar ratio of ligand/metal of 4/1, (2 ml per 3.7 mg of [RuCl₂(p-cymene)]₂. This suspension is agitated for 1 hour at 80° C. A change of colour from yellow to red of the reaction medium is observed.

### EXAMPLE 17

### Use of the Catalyst Complexes Prepared in Example 16 in the Reduction of Acetophenone

At ambient temperature, the catalyst prepared in example 16 and acetophenone are added (molar ratio of substrate/metal: 20/1). Then a solution of 0.03 mol/l of potassium tertiobutylate in isopropanol (ratio of Ru/base: 1/5) is added. The reaction mixture is agitated magnetically. Sampling is carried out over the course of time and the samples are analysed. The enantiomeric excesses are determined by GPC on a chiral column, type Supelco (Lipodex A 30×25). The results obtained are summarised in the following table:

| Example | Complex | Time (hrs) | Conversion (%) | e.e. (%) |
|---|---|---|---|---|
| 17 | 16 | 3 days | 51 | 57 |

1. An optically active polymer that can be obtained by radical or anionic polymerisation of an optically active ethylene monomer with epoxide function bearing at least one chiral centre, optionally in the presence of one or more copolymerisable ethylene monomers, said reaction being carried out under conditions not bringing about the opening of the epoxide functions.

2. A polymer according to claim 1 that can be obtained by copolymerisation of an optically active ethylene monomer with epoxide function bearing at least one chiral centre with a copolymerisable ethylene monomer.

3. A polymer according to claim 2, characterised in that the molar ratio of the desired fraction of the optically active ethylene monomer with epoxide functions to the fraction derived from the copolymerisable ethylene monomer varies from 1-100 : 0-99.

4. A polymer according to one of claims 1 to 3, characterised in that each ethylene monomer comprises a carbonyl, ester, nitrile, amide or ether function at alpha of the ethylene double bond.

5. A polymer according to any one of claims 1 to 4, characterised in that each copolymerisable ethylene monomer comprises at least two ethylene double bonds each having a carbonyl, ester, nitrile, amide or ether group at alpha of the double bond.

6. A polymer according to any one of claims 1 to 5, characterised in that it is composed of two types of repeat units A and B of the formula 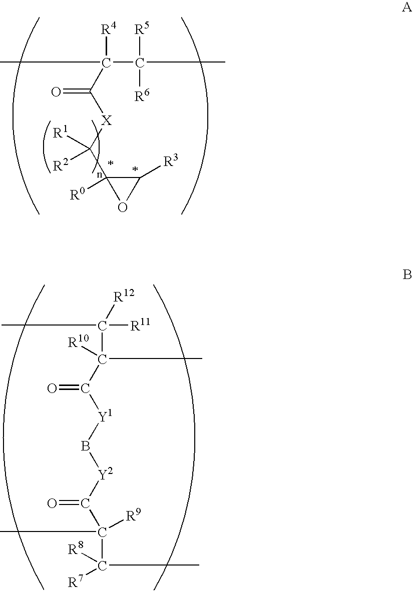
the unit A bearing at least one optically active chiral centre at the epoxide function;
wherein:
indicates the optional location of a carbon of well-determined R or S stereochemistry;
n is an integer between 1 and 10, preferably selected from 1, 2, 3 and 4;
X, Y¹ and Y² are independently selected from —O—, —S— and —NT- where T represents a hydrogen atom; an alkyl, cycloalkyl or aryl group, said group being optionally substituted;
B represents a divalent radical selected from alkylene; cycloalkylene; alkylene interrupted by one or more arylene or/and cycloalklyene groups; or arylene; each of the alkylene, cycloalkylene or arylene groups being optionally substituted;
R⁰, R¹, R², R³, R⁴, R⁵, R⁶, R⁷, R⁸, R⁹, R¹⁰, R¹¹ and R¹² are independently selected from a hydrogen atom, an alkyl, cycloalkyl or aryl group, said group being optionally substituted;
R⁷, R⁸, R⁹, R¹⁰, R¹¹ and R¹² represent independently alkoxy, optionally substituted, aryloxy, optionally substituted, alkylcarbonyloxy, optionally substituted, or arylcarbonyloxy, optionally substituted;
it being understood that R⁵, R⁶, R⁷, R⁸, R¹¹ and R¹² may further represent 1-alkenyl, and R⁷, R⁸ and R⁹ may further represent a polysiloxyl group.

7. A polymer according to claim 6, characterised in that X, Y¹ and Y² represent an oxygen atom and B represents alkylene, optionally substituted.

8. A polymer according to any one of claims 6 to 7, characterised in that R⁰ and R³ represent independently a hydrogen atom, an aryl group, optionally substituted; or an alkyl group, optionally substituted; R⁴ represents alkyl, optionally substituted, or an aryl group, optionally substituted; and R¹ and R² are independently selected from a hydrogen atom, an alkyl group, optionally substituted, or an aryl group, optionally substituted; and R⁵ and R⁶ are independently selected from a hydrogen atom, an alkyl group, optionally substituted, and an aryl group, optionally substituted.

9. A polymer according to. any one of claims 6 to 8, characterised in that R⁹ and R¹⁰ are independently selected from alkyl, optionally substituted, and an aryl group, optionally substituted; R⁷, R⁸, R¹¹ and R¹² represent independently a hydrogen atom, an alkyl group, optionally substituted, or an aryl group, optionally substituted.

10. A polymer according to any one of claims 6 to 9, characterised in that R⁰, R¹, R², R⁵, R⁶, R⁷, R⁸, R¹¹ and R¹² represent a hydrogen atom; R⁴, R⁹, R¹⁰ represent a methyl group; and R³ represents H, methyl or phenyl.

11. A polymer according to claim 10 wherein X, Y¹, and Y² represent an oxygen atom and B represents ethylene.

12. A polymer according to any one of claims 1 to 4, characterised in that the ethylene monomer with epoxide function comprises a carbonyl, ester or amide function at alpha of the ethylene double bond, and in that the copolymerisable ethylene monomer comprises at least two ethylene double bonds.

13. A polymer according to any one of claims 1 to 4 and 12, characterised in that it is composed of two types of repeat units A and C of the formulae 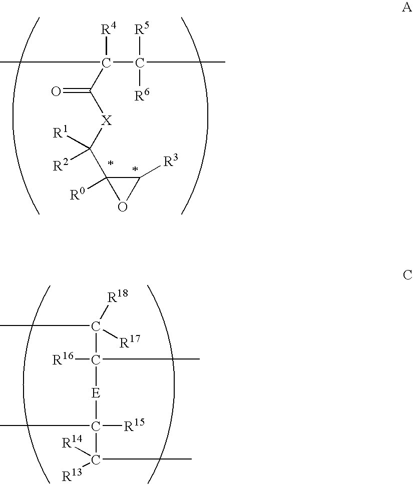
the unit A bearing at least one optically active chiral centre at the epoxide function;
wherein:
* indicates the optional location of a carbon of well-determined R or S stereochemistry;
n is an integer between 1 and 10, preferably selected from 1, 2, 3 and 4;
X is selected from —O—, —S— and —NT- where T represents a hydrogen atom, an alkyl, cycloalkyl or aryl group, said group being optionally substituted;
E is selected from alkylene, optionally substituted, and optionally interrupted by one or more divalent groups —Si(A) (B)- where A and B are independently selected from alkyl, optionally substituted, or aryl, optionally substituted; the divalent group of formula -Ch¹-Ar^{o}-Ch²- where Ch¹, Ch² represent independently a bond, an oxygen atom, a sulphur atom or —NT-, T being such as defined above and Ar^{o} represents arylene, optionally substituted; a bond; an oxygen atom; the divalent group —NT- in which T represents a hydrogen atom, an alkyl group, optionally substituted, or an aryl group, optionally substituted or an —Ar¹—X¹-alk-X²—Ar²— chain where Ar¹ and Ar² are independently selected from arylene, optionally substituted, alk represents alkylene, optionally substituted, and X, X² represent independently C or —NTO—, T^{o} being such as defined above for T;
R⁰, R¹, R², R³, R⁴, R⁵, R⁶, R¹³, R¹⁴, R¹⁵, R¹⁶, R¹⁷ and R¹⁸ are independently selected from a hydrogen atom, an alkyl, cycloalkyl or aryl group, said group being optionally substituted;
R¹³, R¹⁴, R¹⁵, R¹⁶, R¹⁷ and R¹⁸ may further represent alkoxy, optionally substituted; aryloxy, optionally substituted; alkylcarbonyloxy, optionally substituted; arylcarbonyloxy, optionally substituted; or a polysiloxyl group;
it being understood that R⁵, R⁶, R¹³, R¹⁴, R¹⁷ and R¹⁸ may further represent 1-alkenyl, and R¹³, R¹⁴ and R¹⁵ may further represent a polysiloxyl group.

14. A polymer according to claim 13, characterised in that X represents an oxygen atom.

15. A polymer according to any one of claims 13 to 14, characterised in that R⁰ and R³ represent independently a hydrogen atom; an aryl group, optionally substituted; an alkyl group, optionally substituted; R⁴ represents alkyl, optionally substituted, or an aryl group, optionally substituted;. and R¹ and R² are independently selected from a hydrogen atom, an alkyl group, optionally substituted; and an aryl group, optionally substituted; and R⁵ and R⁶ are independently selected from a hydrogen atom, an alkyl group, optionally substituted, and an aryl group, optionally substituted.

16. A polymer according to any one of claims 13 to 15, characterised in that R⁰, R¹, R², R⁵, R⁶, R¹³, R¹⁴, R¹⁵, R¹⁶, R¹⁷ and R¹⁸ represent a hydrogen atom; E represents phenylene; n is 1; X represents an oxygen atom; R⁴ represents methyl and R³ represents a hydrogen atom or a phenyl group.

17. A method for preparing a polymer according to any one of claims 1 to 16, characterised in that an optically active monomer with epoxide function bearing at least one chiral centre is polymerised radically, if necessary in the presence of one or more other copolymerisable ethylene monomers, the polymerisation being conducted in the presence of a radical initiator.

18. A method according to claim 17, characterised in that the radical initiator is azobisisobutyronitrile or benzoyl peroxide.

19. A method according to either of claims 17 and 18, characterised in that the monomer with epoxide function has the formula I: 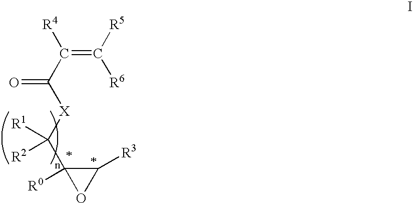
wherein
* indicates the optional location of a carbon of well-determined R or S stereochemistry;
n is an integer between 1 and 10, preferably selected from 1, 2, 3 and 4;
X represents —O—, —S— or —NT- where T represents a hydrogen atom; an alkyl, cycloalkyl or aryl group, said group being optionally substituted;
R⁰, R¹, R², R³, R⁴, R⁵ and R⁶ are independently selected from a hydrogen atom; an alkyl, cycloalkyl, aryl, alkoxy, alkylcarbonyloxy or arylcarbonyloxy group, said group being optionally substituted;
it being understood that R⁵ and R⁶ may further represent 1-alkenyl;
with a copolymerisable monomer of formula II: 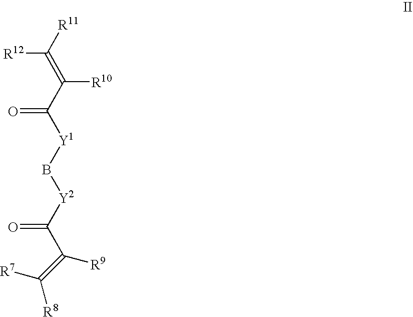
wherein:
Y¹, Y² represents —O—, —S— or —NT- where T represents a hydrogen atom, an alkyl, cycloalkyl or aryl group, said group being optionally substituted;
B represents alkylene, cycloalkylene, arylene or alkylene interrupted by one or more arylene and/or cycloalkylene; each alkylene, cycloalkylene or arylene being optionally substituted;
R⁷, R⁸, R⁹, R¹⁰, R¹¹ and R¹² are independently selected from a hydrogen atom, an alkyl, cycloalkyl, ary.l, alkoxy, aryloxy, alkylcarbonyloxy or arylcarbonyloxy group, said group being optionally substituted;
it being understood that R⁷, R⁸, R¹¹ and R¹² may further represent 1-alkenyl, and R⁷, R⁸ and R⁹ may further represent a polysiloxyl group.

20. A method according to claim 19, characterised in that in formula I, X represents O and in formula II, Y¹ and Y² both represent an oxygen atom and B represents alkylene, optionally substituted, or an arylene group, optionally substituted, or an arylene group, optionally substituted.

21. A method according to any one of claims 19 and 20, characterised in that in formula I, R⁰ and R³ represent independently a hydrogen atom, an aryl group, optionally substituted, or an alkyl group, optionally substituted; R⁴ represents alkyl, optionally substituted, or an aryl group, optionally substituted; and R¹ and R² represent independently a hydrogen atom, an alkyl group, optionally substituted, or an aryl group, optionally substituted and R⁵ and R⁶ are independently selected from a hydrogen atom, an alkyl group,optionally substituted, and an aryl group, optionally substituted.

22. A method according to any one of claims 19 to 21, characterised in that in formula II, R⁹ and R¹⁰ are independently selected from substituted alkyl and an optionally substituted aryl group; and R⁷, R⁸, R¹¹ and R¹² represent independently a hydrogen atom, an alkyl group, optionally substituted, or an aryl group, -optionally substituted.

23. A method according to any one of claims 19 to 22, characterised in that in formula I, R⁰, R¹, R², R⁵ and R⁶ represent a hydrogen atom; R⁴ represents alkyl, optionally substituted and, in formula II, R⁷, R⁸, R¹¹ and R¹² are hydrogen atoms and R⁹ and R¹⁰ represent a methyl group; and R³ represents H, a methyl group or a phenyl group.

24. A method according to claim 14, characterised in that R⁰, R¹, R², R⁵, R⁶, R⁷, R⁸, R¹¹ and R¹² represent a hydrogen atom; R⁴, R⁹ and R¹⁰ represent a methyl group; and X, Y¹ and Y² represent an oxygen atom.

25. A method according to any one of claims 17 and 18, characterised in that the monomer with epoxide function has the formula I: 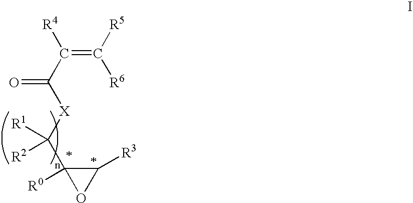
* indicates the optional location of a carbon of well-determined R or S stereochemistry;
n is an integer between 1 and 10, preferably selected from 1, 2, 3 and 4;
X represents —O—, —S— or —NT- where T represents a hydrogen atom; an alkyl, cycloalkyl or aryl group, said group being optionally substituted;
R⁰, R¹, R² , R³, R⁴, R⁵ and R⁶ are independently selected from a hydrogen atom; an alkyl, cycloalkyl or aryl group, said group being optionally substituted;
it being understood that R⁵ and R⁶ may further represent 1-alkenyl; with a copolymerisable monomer of the formula III: 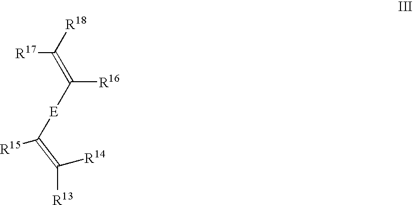
wherein
E is selected from alkylene, optionally substituted, and optionally interrupted by one or more divalent groups —Si(A) (B)- where A and B are independently selected from alkyl, optionally substituted, or aryl, optionally substituted; the divalent group of formula -Ch¹-Ar^{o}-Ch²- where Ch¹, Ch² represent independently a bond, an oxygen atom, a sulphur atom or —NT-, T being such as defined above and Ar^{o} represents arylene, optionally substituted a bond; an oxygen atom; the divalent group —NT- in which T represents a hydrogen atom, an alkyl group, optionally substituted, or an aryl group, optionally substituted or an —Ar¹—X¹-alk-X²—Ar²— chain where Ar¹ and Ar² are independently selected from arylene, optionally substituted, alk represents alkylene, optionally substituted, and X, X² represent independently O or —NT^{o}-, T^{o} being-such as defined above for T;
R¹³, R¹⁴, R¹⁵, R¹⁶, R¹⁷ and R¹⁸ are independently selected from a hydrogen atom, an alkyl, cycloalkyl, aryl, alkoxy, aryloxy, alkylcarbonyloxy or arylcarbonyloxy group, said group being optionally substituted;
it being understood that R¹³₁, R¹⁴, R¹⁷ and R¹⁸ may further represent 1-alkenyl, and R¹³, R¹⁴ and R¹⁵ may further represent a polysiloxyl group.

26. A method according to claim 25, characterised in that in formula I, X represents an oxygen atom.

27. A method according to either of claims 25 and 26, characterised in that in formula I, R⁰ and R³ represent independently a hydrogen atom; an aryl group, optionally substituted; or an alkyl group, optionally substituted; R⁴ represents alkyl, optionally substituted, or an aryl group, optionally substituted; and R¹ and R² independently represent a hydrogen atom or an alkyl group, optionally substituted; and R⁵ and R⁶ are independently selected from a hydrogen atom, an alkyl group, optionally substituted, and an aryl group, optionally substituted.

28. A method according to any one of claims 25 to 27, characterised in that in formula III, R¹⁵ and R¹⁶ are independently selected from alkyl, optionally substituted, aryl, optionally substituted and a hydrogen atom; and R¹³, R¹⁴, R¹⁷ and R¹⁸ represent independently a hydrogen atom, an alkyl group, optionally substituted, or an aryl group, optionally substituted.

29. A method according to any one of claims 25 to 28, characterised in that in formula I, R⁰, R¹, R², R⁵ and R⁶ represent a hydrogen atom; R⁴ represents alkyl, optionally substituted, and R³ represents H or phenyl and, in formula III, R¹³, R¹⁴, R¹⁷ and R¹⁶ are hydrogen atoms; R¹⁵ and R¹⁶ represent a methyl group, a phenyl group or a hydrogen atom.

30. A method according to any one of claims 25 to 29, characterised in that the compound of formula I is glycidyl methacrylate and the compound of formula III is a divinylbenzene.

31. A method according to any one of claims 17 to 30, characterised in that polymerisation is carried out in a biphase medium comprising water, an organic solvent and a very hydrophilic polar compound selected from polyvinylpyrrolidone; polyvinyl alcohols and their ethers; polyvinylacetates, polyvinylacetamides, gelatin, methyl cellulose, polymethacrylamides, salts of polymethacrylic acid, polymethacrylic acid; phosphates of alkaline earth metals; and the polymers resulting from the polymerisation of one of the following monomers with ethylene double bond: 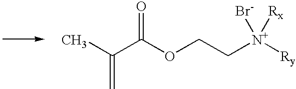
where Rₓ and R_{y} represent independently a hydrocarbon chain, it being understood that at least one of Rₓ or R_{y} is a fatty hydrocarbon chain, having from 8 to 24 carbon atoms: 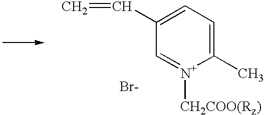
where R_{z} is such as defined above for Rₓ and has from 8 to 24 carbon atoms;

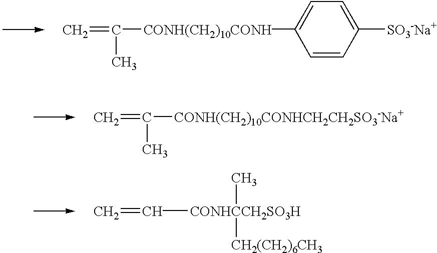

32. A method according to claim 31, characterised in that said organic solvent is selected from aromatic hydrocarbons, optionally substituted; aliphatic hydrocarbons, halogenated or not; ketones; amides; esters; pyridine; propylene carbonate; cyclic ethers; C₄-C₈ cycloalkanols; C₁-C₁₈ alkanols; and mixtures thereof.

33. A method according to claim 31 or claim 32, characterised in that the biphase medium further comprises porogenic solvents selected from C₅-C₈ cycloalkyl alcohol and C₁-C₁₈ alkanol.

34. A method according to claim 33, characterised in that the biphase medium comprises, as porogenic solvents, a mixture of cyclohexanol and dodecanol or a mixture of cyclohexanol and lauryl alcohol.

35. A method according to any one of claims 17 to 30, characterised in that polymerisation is carried out anionically in the presence of a stabiliser of the active centre of the polymerisation selected from tertio-alcoholates of alkaline metals; alkaline metal halides; polydentate alcoholates of alkaline metals; and alkylaluminiums.

36. A method according to claim 35, characterised in that the stabiliser is selected from lithium chloride; lithium tert-butylate; and lithium 3-methyl-3-pentylate, the preferred stabiliser being lithium chloride.

37. A method according to either of claims 35 and 36, characterised in that polymerisation is carried out in the presence of a polymerisation initiator selected from alkyllithiums; enolates of esters of alkaline metals; and primary and secondary alcoholates of alkaline metals.

38. A method according to claim 37, characterised in that the polymerisation initiator is selected from sec-butyllithium; 1,1-diphenyl-3-methylpentyllithium; and 1,1,4,4-tetraphenyl-1,4-dilithiobutane.

39. A method according to any one of claims 35 to 38, characterised in that polymerisation is carried out in a solvent selected from aliphatic, cyclic or aromatic hydrocarbons; ethers, pyridine and mixtures thereof.

40. A method according to any one of claims 35 to 39, characterised in that polymerisation is carried out at a temperature ranging between −100° C. and 0° C., preferably between −60° C. and −30° C.

41. An optically active polymer, that can be obtained by regiospecific stereoselective reaction of a nucleophilic agent on a polymer such as de-fined in any one of claims 1 to 16, by which the partial or total regiospecific stereoselective opening of the epoxide functions of said reactive polymer is brought about.

42. A polymer according to claim 41, characterised in that said nucleophilic agent comprises as nucleophilic site a halogen atom, a carbon atom, an oxygen atom, a sulphur atom, a nitrogen atom, a phosphorus atom or a selenium atom.

43. A polymer according to claim 42, characterised in that said nucleophilic agent is an amine, a guanidine, a morpholine or a hydroxylamine.

44. The use of a polymer according to any one of claims 1 to 16 as polymeric material for immobilising enzymes.

45. The use of a polymer according to any one of claims 41 to 43 as polymeric matrix usable in chiral chromatography.

46. The use of a polymer according to any one of claims 41 to 43 as polymeric support usable in solid phase synthesis.

47. The use of a polymer according to any one of claims 41 to 43 as a ligand, optionally after transformation into oxazaborolidine or phosphoramidate in the preparation of transition metal complexes or as chiral inducer, in stereoselective catalysis.

48. The use according to claim 47 for catalysing the stereoselective reduction of carbonyl and imine functions or for catalysing reactions involving the formation of C—C bonds.

49. A polymeric material usable as stationary phase in-chiral chromatography, that may be obtained by the reaction of grafting of a polymer according to any one of claims 41 to 43 onto a support conventionally used in chromatography.

50. The use of a polymeric material according to claim 49 in chiral chromatography.

51. A metallic complex of a transition metal comprising a polymer according to any one of claims 1 to 16 or 41 to 43 as a ligand.

52. A complex according to claim 51, characterised in that the transition metal is ruthenium, iridium or rhodium, preferably ruthenium.
